(19) United States
(12) Patent Application Publication
(10) Pub. No.: US 2022/0120175 A1
(43) Pub. Date: Apr. 21, 2022

(54) PIPE CONNECTION INCLUDING AN EXPANDABLE ELASTOMER SLEEVE IN CONTACT WITH AN INTERNAL PROTECTIVE COATING

(71) Applicant: SharpKeen Enterprises, Inc., Lehi, UT (US)

(72) Inventor: Joel Guzman, Lehi, UT (US)

(73) Assignee: SharpKeen Enterprises, Inc., Lehi, UT (US)

(21) Appl. No.: 17/516,523

(22) Filed: Nov. 1, 2021

Related U.S. Application Data
(63) Continuation-in-part of application No. 16/813,190, filed on Mar. 9, 2020, now Pat. No. 11,162,355.
Application No. 16/813,190 is a continuation of application No. 16/168,738, filed on Oct. 23, 2018, now Pat. No. 10,584,580.
(60) Provisional application No. 62/575,941, filed on Oct. 23, 2017.

(51) Int. Cl. E21B 47/13; E21B 17/00; H01P 3/16; E21B 17/02; G01V 3/30; H01P 3/12; H01P 3/123; G01V 11/00

(52) U.S. Cl. CPC E21B 47/13; E21B 17/006; H01P 3/16; E21B 17/028; G01V 11/002; E21B 17/003; H01P 3/122; H01P 3/123; G01V 3/30

(57) ABSTRACT

Systems and devices for connecting a plurality of pipes secured end-to-end are disclosed. A system of the disclosure includes a plurality of pipes connected end-to-end forming a pipe string. Each pipe of the plurality of pipes includes an exterior wall, an interior surface, and an internal protective coating. A first connection end of a first pipe includes a hollow flexible sleeve disposed on the interior surface of a first pipe. A second connection end of a second pipe is configured to receive the hollow flexible sleeve of the first pipe therein. When the first connection end is connected to the second connection end, the hollow flexible sleeve contacts the internal protective coating of the second pipe.

### CROSS-REFERENCE TO RELATED APPLICATIONS

This application is a continuation-in-part of co-pending U.S. patent application Ser. No. 16/813,190, filed Mar. 9, 2020 (now U.S. Pat. No. 11,162,355), which is a continuation of U.S. patent application Ser. No. 16/168,738, filed Oct. 23, 2018 (now U.S. Pat. No. 10,584,580), which claims the benefit under 35 U.S.C. § 119(e) of U.S. Provisional Patent Application No. 62/575,941 filed Oct. 23, 2017 and titled “ELECTROMAGNETIC WAVE COMMUNICATION IN A PIPE,” which is incorporated herein by reference in its entirety, including but not limited to those portions that specifically appear hereinafter, the incorporation by reference being made with the following exception: In the event that any portion of the above-referenced application is inconsistent with this application, this application supersedes said above-referenced application.

### STATEMENT REGARDING FEDERALLY SPONSORED RESEARCH OR DEVELOPMENT

Not applicable.

### TECHNICAL FIELD

The present disclosure relates to systems, methods, and devices for communication along a pipe or pipe chain and more particularly relates to systems, methods, and devices for electromagnetic wave communication in a downhole pipe chain.

### BACKGROUND

Oil rigs can be exceptionally dangerous places to work. Over the last several decades, oil rig explosions have been responsible for numerous environmental disasters, worker injuries, and worker deaths. Oil rig automation provides significant productivity benefits and can prevent or reduce oil rig accidents and any associated injuries to oil rig workers. The automation of an oil rig requires the use of monitoring systems. Such monitoring systems may use a variety of sensors that are located deep beneath the surface and must communicate with a device above-ground.

Automated monitoring systems provide significant benefits to the drilling industry. The reliance on automated monitoring systems can provide an improved means for service companies to plan a successful and productive well providing real-time information avoiding costly decisions, reducing non-productive time, reducing days of drilling and predicting and stopping oil rig accidents before they occur. However, such automated monitoring systems known in the art have many limitations. Systems, methods, and devices for improved surface wave communication in a drill pipe are disclosed herein.

### BRIEF DESCRIPTION OF THE DRAWINGS

FIG. 1 is a schematic diagram illustrating an example oil rig with drill string;

FIG. 2 is a perspective view of a drill pipe illustrating an internal protective coating (IPC), according to one embodiment;

FIG. 3 is an end view of a drill pipe illustrating an internal protective coating (IPC), according to one embodiment;

FIG. 4 is a side view of a drill pipe illustrating an internal protective coating (IPC), according to one embodiment;

FIG. 5 illustrates a system for drill string communication, according to one embodiment;

FIG. 6 illustrates example drill string components, according to one embodiment;

FIG. 7 illustrates an interface between a pin end of first pipe and a box end of second pipe with signals traveling between a pipe wall and IPC, according to one embodiment;

FIG. 8A is a schematic side view of a drill pipe with an embedded waveguide, according to one embodiment;

FIG. 8B is a schematic side cross-sectional view of a drill pipe with an embedded waveguide and a plurality of couplers, according to one embodiment;

FIG. 8C is a schematic side cross-sectional view of a first pipe and a second pipe having a conical coupler, according to one embodiment;

FIG. 9 is a schematic side view of an end of a drill pipe illustrating a three-dimensional cone shape of a conductor according to one embodiment;

FIG. 10A is a schematic side view of a drill pipe or other tubular member with a built-in transceiver and a plurality of couplers, according to one embodiment;

FIG. 10B is a schematic cross-sectional side view of a drill pipe or other tubular member with a built-in transceiver and a plurality of couplers, according to one embodiment;

FIG. 11A is a schematic side view of a drill pipe with a transceiver and housing that can be clamped to an outside of the pipe, according to one embodiment;

FIG. 11B is an aerial view of a drill pipe with a transceiver and housing that can be clamped to an outside of the pipe, according to one embodiment;

FIG. 12 is a schematic diagram illustrating a simplified equivalent tuned circuit for transmitting information using the pipe or conductor as a signal medium or waveguide, according to one embodiment;

FIG. 13 is a diagram illustrating how information or power may be transmitted between transmitters located on different pipes and/or with multiple intervening pipes, according to one embodiment;

FIG. 14 is a side view of a pipe with a transceiver to be used at the top of a drill string, according to one embodiment; and

FIG. 15 is a schematic block diagram of a transceiver, according to one embodiment.

FIG. 16A is a perspective view of a drill pipe connection with a coupler in a separated condition, according to one embodiment;

FIG. 16B is a perspective view of a drill pipe connection in a connected condition, according to one embodiment;

FIG. 17A is a side cross-sectional view of a female connection end that receives the male connection end;

FIG. 17B is a top cross-sectional view of a female connection end that receives the male connection end;

FIG. 18A is a perspective view of a collapsible flexible sleeve in a drill pipe connection, where the flexible sleeve is shown in an extended state, according to one embodiment;

FIG. 18B is a perspective view of the collapsible flexible sleeve in a drill pipe connection, where the flexible sleeve is shown in a collapsed state, according to one embodiment;

FIG. 19A is an internal view of a male connection end of a drill pipe showing the collapsible flexible sleeve seated inside the male connection end;

FIG. 19B is an internal view of a male connection end of a drill pipe showing the collapsible flexible sleeve seated inside the male connection end in the collapsed state;

FIG. 19C is an internal view of a male connection end of a drill pipe showing the collapsible flexible sleeve seated inside the male connection end in the extended state;

FIG. 20A is an internal view showing the male connection end and flexible sleeve disposed within the female connection end;

FIG. 20B is an internal view showing the male connection end and flexible sleeve disposed within the female connection end;

FIG. 21A is a perspective view of the collapsible flexible sleeve and a hollow expander that may be inserted into the collapsible flexible sleeve;

FIG. 21B is a perspective view of the hollow expander disposed inside the flexible sleeve;

FIG. 22A is a perspective view of the collapsible flexible sleeve disposed on the hollow expander with the collapsible flexible sleeve in a compressed or rolled-up position;

FIG. 22B is a perspective view of the collapsible flexible sleeve disposed on the hollow expander with the collapsible flexible sleeve in an extended position;

FIG. 23A is a front view of a collapsible flexible sleeve or other element that may be clamped or fixed to an inner surface of a pipe and a ring-shaped clamp;

FIG. 23B is a front view of the ring-shaped clamp around a base of the element;

FIG. 24A is a perspective view showing a connection of a pin and box pipe connector according to at least one embodiment;

FIG. 24B is a perspective view showing a connection of a pin and box pipe connector shown in FIG. 24A. The male and female connection ends are shown in a connected configuration;

FIG. 24C is an internal view showing the connection in a connected state;

FIG. 25A is a perspective view of a threaded extendable connector according to at least one embodiment, shown in a retracted position;

FIG. 25B is a perspective view of the threaded extendable connector according to at least one embodiment, shown in an extended position;

FIG. 26A is a perspective view of the threaded extendable connector at an end of a pipe connecting to a connector sleeve at an end of another pipe;

FIG. 26B is a perspective view of the threaded extendable connector at an end of a pipe connecting to a connector sleeve at an end of another pipe; and

FIG. 26C is a perspective view of the threaded extendable connector at an end of a pipe connecting to a connector sleeve at an end of another pipe.

### DETAILED DESCRIPTION

The systems, methods, and devices described herein provide a new means for conducting communications and transmissions in a downhole pipe, such as a drill pipe utilized in an oil or gas drilling rig. Automated drilling is on the rise, but the communication networks and systems for controlling automated drilling have severe limitations. Such communications can be exceptionally slow and require significant upkeep. In an embodiment known in the art, a coaxial cable may be run down the hollow shaft of a drill string and the coaxial cable may undergo significant wear and tear caused by drilling operations. In further embodiments, significant modifications may be made to drilling pipes to enable communication lines to travel downhole. Such modifications can be costly and require extensive upkeep.

The drilling of oil and gas wells can be exceptionally dangerous. Oil rig explosions can cause severe environmental disasters and cause injury or death for oil rig workers. Numerous components of an oil rig can fail and cause devastating consequences if the oil rig is not shut off or the component is not quickly repaired or replaced. Monitoring systems can be installed on oil rig components so that workers can receive a prewarning of a possible deteriorating condition of an oil rig component. Essential machinery in an oil rig must be constantly monitored to prevent an explosion or other disaster and to maintain awareness of the life expectancy of oil rig components.

Monitoring equipment used for oil and gas drilling can detect numerous problems, including for example, rolling element bearing damages, gear wear and damage, imbalance, misalignment in shafts and gears, looseness, structural resonances, motor rotor and shaft eccentricity, and electrical motor problems. Often, such monitoring equipment includes sensors located deep beneath the surface that must communicate with above-ground devices. The communication capabilities for such monitoring systems known in the art have many limitations.

Communications between above-ground devices and underground monitoring sensors can be very slow. For example, wireless communications from underground locations such as mud-pulse, ultrasound, and magnetic flux telemetry methods are very slow (around 40 bits per second) and typically require the stopping of all drilling activity to get a reading. A leading wired technique is high-speed telemetry through coaxial transmission lines and inductive couplers which may provide speeds of up to 56 Kbps using a 5 MHz signal. However, this technology is not financially practical because it requires expensive modifications to the drill string components. Other hardwired devices are also used (wire-line devices), but they also present their own set of drawbacks such as the need to drop the device downhole through the top of the well. The wireless methods mentioned above require the use of batteries, which in turn, require frequent replacement due to the extreme underground environment.

Numerous methods have been attempted to improve communications with oil rig monitoring systems. One such method includes transmitting through the drill pipe itself, but the permeability of the steel material used in drill pipe does not permit using the pipe itself as a conductor of Radio Frequencies (RF) or any frequencies above Radio. This has dissuaded manufacturers and operators in the industry from using the drill pipe as a conductor for signal or for power communications. The challenges associated with using the drill pipe as a transmission line are compounded by the downhole environment that greatly impedes wireless signal transmissions within short distances.

Further challenges faced in the oil drilling industry arising from the coupling methods utilized from component to component within a string of drilling components. Such coupling methods include, for example, direct contact, inductive, capacitive, acoustic, piezoelectric, and so forth. The coupling methods introduce additional signal constraints such as wire insertion losses, band-pass filtering, scatter waves, and signal distortion. The additional signal constraints limit the frequency of a signal carrier and the volume of data traffic that may be carried. This is compounded by the integrity of the mechanical connection between coupled devices that requires a high number of signal restorers or conditioners within the string.

Systems, methods, and devices for improving downhole communications are disclosed herein. Embodiments disclosed herein overcome the above challenges and obstacles by converting conventional drill pipe and other string components to act as a single wire transmission medium (in essence an electro-magnetic waveguide) that, in conjunction with specially designed transceivers using modern communication technologies (such as in smart phone and other portable devices' technology), form a system in a drill string to transmit communication signals and/or power up or down hole. In some embodiments, the systems, methods, and devices disclosed herein eliminate the need for special transmission lines, electrical connectors or contacts, inductive or capacity couples, or seals between string components. However, in other embodiments electrical connectors or contacts, inductive or capacity couples, or seals between string components may be implemented without departing from the scope of the disclosure. Additionally, in some embodiments embedded electrical connections may be utilized within the flexible sleeve described herein.

In contrast with the conventional way a transmission line is utilized where the signal is expected to travel throughout the body of an electrical conductor and requiring a return path, the present disclosure leverages the natural phenomena of “Skin Effect” at high frequencies where the electromagnetic signal travels within the gap of two adjacent bodies with different dielectric characteristics without the need of an electrical return path. A very broad spectrum of frequencies, for example 100 MHz to 300 GHz, can be transmitted bidirectionally and processed this way. This permits the systems disclosed herein to implement modern modulation techniques such as phase shifting keying, quadrature amplitude modulation, multi-carrier modulation, orthogonal frequency division multiplexing and use multiple access techniques. Protocols and applications that could be processed by this system can include telephone, video, voice and data, WIFI, satellite, cable, ethernet, telemetry, and others. Additionally, the systems disclosed herein can be utilized to transmit power signals to remote devices downhole where a signal may be processed by resonant circuits to generate power. The generated power may drive motors or charge capacitors or batteries as needed. In the systems, methods, and devices disclosed herein, a plurality of signals having a variety of different purposes may use the same single waveguide.

U.S. Pat. No. 9,640,850 to Henry et al. titled “METHODS AND APPARATUS FOR INDUCING A NON-FUNDAMENTAL WAVE MODE ON A TRANSMISSION MEDIUM” discloses a system for generating first electromagnetic waves and directing instances of the first electromagnetic waves to an interface of a transmission medium to induce propagation of second electromagnetic waves having at least a dominant non-fundamental wave mode. U.S. Pat. No. 9,640,850 is hereby incorporated by reference in its entirety within the present application. The following paragraphs are an excerpt from column 4 line 16 through column 7 line 16 of U.S. Pat. No. 9,640,850.

“In an embodiment, a guided wave communication system for sending and receiving communication signals such as data or other signaling via guided electromagnetic waves. The guided electromagnetic waves include, for example, surface waves or other electromagnetic waves that are bound to or guided by a transmission medium. It will be appreciated that a variety of transmission media can be utilized with guided wave communications without departing from example embodiments. Examples of such transmission media can include one or more of the following, either alone or in one or more combinations: wires, whether insulated or not, and whether single-stranded or multi-stranded; conductors of other shapes or configurations including wire bundles, cables, rods, rails, pipes; non-conductors such as dielectric pipes, rods, rails, or other dielectric members; combinations of conductors and dielectric materials; or other guided wave transmission media.”

“The inducement of guided electromagnetic waves on a transmission medium can be independent of any electrical potential, charge or current that is injected or otherwise transmitted through the transmission medium as part of an electrical circuit. For example, in the case where the transmission medium is a wire, it is to be appreciated that while a small current in the wire may be formed in response to the propagation of the guided waves along the wire, this can be due to the propagation of the electromagnetic wave along the wire surface, and is not formed in response to electrical potential, charge or current that is injected into the wire as part of an electrical circuit. The electromagnetic waves traveling on the wire therefore do not require a circuit to propagate along the wire surface. The wire therefore is a single wire transmission line that is not part of a circuit. Also, in some embodiments, a wire is not necessary, and the electromagnetic waves can propagate along a single line transmission medium that is not a wire.”

“More generally, “guided electromagnetic waves” or “guided waves” as described by the subject disclosure are affected by the presence of a physical object that is at least a part of the transmission medium (e.g., a bare wire or other conductor, a dielectric, an insulated wire, a conduit or other hollow element, a bundle of insulated wires that is coated, covered or surrounded by a dielectric or insulator or other wire bundle, or another form of solid, liquid or otherwise non-gaseous transmission medium) so as to be at least partially bound to or guided by the physical object and so as to propagate along a transmission path of the physical object. Such a physical object can operate as at least a part of a transmission medium that guides, by way of an interface of the transmission medium (e.g., an outer surface, inner surface, an interior portion between the outer and the inner surfaces or other boundary between elements of the transmission medium), the propagation of guided electromagnetic waves, which in turn can carry energy, data and/or other signals along the transmission path from a sending device to a receiving device.”

“Unlike free space propagation of wireless signals such as unguided (or unbounded) electromagnetic waves that decrease in intensity inversely by the square of the distance traveled by the unguided electromagnetic waves, guided electromagnetic waves can propagate along a transmission medium with less loss in magnitude per unit distance than experienced by unguided electromagnetic waves.”

“Unlike electrical signals, guided electromagnetic waves can propagate from a sending device to a receiving device without requiring a separate electrical return path between the sending device and the receiving device. Consequently, guided electromagnetic waves can propagate from a sending device to a receiving device along a transmission medium having no conductive components (e.g., a dielectric strip), or via a transmission medium having no more than a single conductor (e.g., a single bare wire or insulated wire). Even if a transmission medium includes one or more conductive components and the guided electromagnetic waves propagating along the transmission medium generate currents that flow in the one or more conductive components in a direction of the guided electromagnetic waves, such guided electromagnetic waves can propagate along the transmission medium from a sending device to a receiving device without requiring a flow of opposing currents on an electrical return path between the sending device and the receiving device.”

“In a non-limiting illustration, consider electrical systems that transmit and receive electrical signals between sending and receiving devices by way of conductive media. Such systems generally rely on electrically separate forward and return paths. For instance, consider a coaxial cable having a center conductor and a ground shield that are separated by an insulator. Typically, in an electrical system a first terminal of a sending (or receiving) device can be connected to the center conductor, and a second terminal of the sending (or receiving) device can be connected to the ground shield. If the sending device injects an electrical signal in the center conductor via the first terminal, the electrical signal will propagate along the center conductor causing forward currents in the center conductor and return currents in the ground shield. The same conditions apply for a two-terminal receiving device.”

“In contrast, consider a guided wave communication system such as described in the subject disclosure, which can utilize different embodiments of a transmission medium (including among others a coaxial cable) for transmitting and receiving guided electromagnetic waves without an electrical return path. In one embodiment, for example, the guided wave communication system of the subject disclosure can be configured to induce guided electromagnetic waves that propagate along an outer surface of a coaxial cable. Although the guided electromagnetic waves will cause forward currents on the ground shield, the guided electromagnetic waves do not require return currents to enable the guided electromagnetic waves to propagate along the outer surface of the coaxial cable. The same can be said of other transmission media used by a guided wave communication system for the transmission and reception of guided electromagnetic waves. For example, guided electromagnetic waves induced by the guided wave communication system on an outer surface of a bare wire, or an insulated wire can propagate along the bare wire or the insulated bare wire without an electrical return path.”

“Consequently, electrical systems that require two or more conductors for carrying forward and reverse currents on separate conductors to enable the propagation of electrical signals injected by a sending device are distinct from guided wave systems that induce guided electromagnetic waves on an interface of a transmission medium without the need of an electrical return path to enable the propagation of the guided electromagnetic waves along the interface of the transmission medium.”

“It is further noted that guided electromagnetic waves as described in the subject disclosure can have an electromagnetic field structure that lies primarily or substantially outside of a transmission medium so as to be bound to or guided by the transmission medium and so as to propagate non-trivial distances on or along an outer surface of the transmission medium. In other embodiments, guided electromagnetic waves can have an electromagnetic field structure that lies primarily or substantially inside a transmission medium so as to be bound to or guided by the transmission medium and so as to propagate non-trivial distances within the transmission medium. In other embodiments, guided electromagnetic waves can have an electromagnetic field structure that lies partially inside and partially outside a transmission medium so as to be bound to or guided by the transmission medium and so as to propagate non-trivial distances along the transmission medium. The desired electronic field structure in an embodiment may vary based upon a variety of factors, including the desired transmission distance, the characteristics of the transmission medium itself, and environmental conditions/characteristics outside of the transmission medium (e.g., presence of rain, fog, atmospheric conditions, etc.).”

“Various embodiments described herein relate to coupling devices, that can be referred to as “waveguide coupling devices”, “waveguide couplers” or more simply as “couplers”, “coupling devices” or “launchers” for launching and/or extracting guided electromagnetic waves to and from a transmission medium at millimeter-wave frequencies (e.g., 30 to 300 GHz), wherein the wavelength can be small compared to one or more dimensions of the coupling device and/or the transmission medium such as the circumference of a wire or other cross sectional dimension, or lower microwave frequencies such as 300 MHz to 30 GHz. Transmissions can be generated to propagate as waves guided by a coupling device, such as: a strip, arc or other length of dielectric material; a horn, monopole, rod, slot or other antenna; an array of antennas; a magnetic resonant cavity, or other resonant coupler; a coil, a strip line, a waveguide or other coupling device. In operation, the coupling device receives an electromagnetic wave from a transmitter or transmission medium. The electromagnetic field structure of the electromagnetic wave can be carried inside the coupling device, outside the coupling device or some combination thereof. When the coupling device is in close proximity to a transmission medium, at least a portion of an electromagnetic wave couples to or is bound to the transmission medium and continues to propagate as guided electromagnetic waves. In a reciprocal fashion, a coupling device can extract guided waves from a transmission medium and transfer these electromagnetic waves to a receiver.”

“According to an example embodiment, a surface wave is a type of guided wave that is guided by a surface of a transmission medium, such as an exterior or outer surface of the wire, or another surface of the wire that is adjacent to or exposed to another type of medium having different properties (e.g., dielectric properties). Indeed, in an example embodiment, a surface of the wire that guides a surface wave can represent a transitional surface between two different types of media. For example, in the case of a bare or uninsulated wire, the surface of the wire can be the outer or exterior conductive surface of the bare or uninsulated wire that is exposed to air or free space. As another example, in the case of insulated wire, the surface of the wire can be the conductive portion of the wire that meets the insulator portion of the wire, or can otherwise be the insulator surface of the wire that is exposed to air or free space, or can otherwise be any material region between the insulator surface of the wire and the conductive portion of the wire that meets the insulator portion of the wire, depending upon the relative differences in the properties (e.g., dielectric properties) of the insulator, air, and/or the conductor and further dependent on the frequency and propagation mode or modes of the guided wave.” (U.S. Pat. No. 9,640,850 col. 4 l. 16-col. 7 l. 16.)

As discussed above with respect to U.S. Pat. No. 9,640,850, a waveguide can be any object including a conductor or an insulator. The desired electromagnetic transmission may be in the form of a surface wave attached to the waveguide object and the signal may be coupled through a drill string component as disclosed herein.

In an embodiment, a system for providing downhole communications in a drilling rig is disclosed. The system includes a plurality of pipes connected end-to-end forming a pipe string. In an exemplary embodiment, each of the plurality of pipes is a drill pipe and the pipe string is a drill string for drilling oil or gas. Each of the plurality of pipes includes an exterior wall, an internal protective coating, and a waveguide. The waveguide for each pipe of the plurality of pipes is coupled to at least one other waveguide for at least one other pipe such that a wave path is formed that extends a length of the plurality of pipes. The system includes a transceiver configured to transmit a communication along the wave path.

In an embodiment, the waveguide is disposed between the exterior wall of a pipe and the internal protective coating of a pipe. The waveguide may include an embedded waveguide secured to either of an interior surface of the exterior wall or a surface of the internal protective coating. Such an embedded waveguide may include a plated conductor such as copper or other suitable material. The waveguide may include surface waves propagated between a dielectric difference between the exterior wall and the internal protective coating of a pipe. In an embodiment, the waveguide is propagated by way of the “Skin Effect” phenomena disclosed herein.

In an embodiment, the system further includes a waveguide coupler configured to carry the communication along the wave path between a first pipe that is attached end-to-end to a second pipe. In such an embodiment, each pipe may include a first waveguide coupler at a first end and a second waveguide coupler at a second end. The two waveguides may be oriented such that each is positioned to carry the communication downhole when the pipes are connected end-to-end in a pipe string. The waveguide couplers are configured to ensure that the communication may be transmitted uninterrupted down the wave path with minimized signal losses at each junction where a first pipe is connected to a second pipe. In an embodiment, the waveguide coupler includes, in an embodiment, a spring metal sheet configured to conform to an interior cavity of the pipe without fully obstructing a flow of fluid through the pipe. The coupler may include clamping ears configured to clamp the coupler to an interior surface of the interior cavity of the pipe to prevent the coupler from moving or slipping when it encounters vertical or lateral forces. In an embodiment, a conical coupler is disposed at the ends of each pipe that has a three-dimensional cone shape. A pair of conical couplers may meet and ensure that the communication may travel downhole between a first pipe and a second pipe with minimal signal loss.

In an embodiment, a method for transmitting a communication downhole in a drilling rig is disclosed. The method includes transmitting a communication from a transceiver. The transceiver is configured to transmit the communication along a wave path extending a length of a plurality of pipes connected end-to-end. Each pipe of the plurality of pipes includes an exterior wall, an internal protective coating, and a waveguide. The waveguide for each pipe of the plurality of pipes is connected to at least one other waveguide for at least one other pipe such that the wave path extends the length of the plurality of pipes.

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example” or “an example” means that a particular feature, structure or characteristic described in connection with the embodiment or example is included in at least one embodiment of the present disclosure. Thus, appearances of the phrases “in one embodiment,” “in an embodiment,” “one example” or “an example” in various places throughout this specification are not necessarily all referring to the same embodiment or example. In addition, it should be appreciated that the figures provided herewith are for explanation purposes to persons ordinarily skilled in the art and that the drawings are not necessarily drawn to scale.

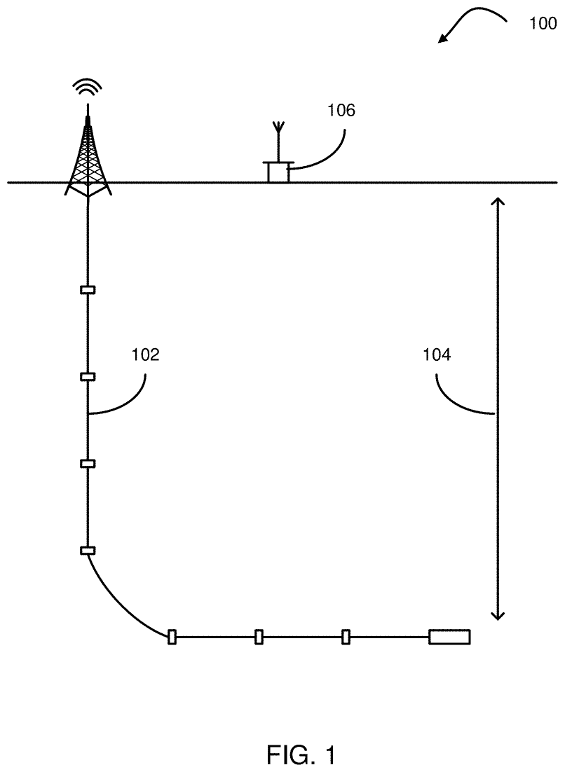

FIG. 1 illustrates an oil rig 100 with a drill string 102 at a depth 104. In an example implementation, the depth 104 may be deep beneath the surface, such as one mile beneath the surface or deeper. A wireless telemetry station 106 on the surface may communicate wirelessly with one or more transceivers on top of the drill string 102. With coaxial transmission lines, a coaxial cable may be mounted to a pipe or other component of the drill string 102.

The drill string 102 on a drilling rig is a column, or string, of a plurality of drill pipes that transmit drilling fluid and torque to the drill bit. The drilling fluid is transmitted by way of a mud pump and torque is transmitted by way of a Kelly drive or top drive. The drill string 102 may refer to the assembled collection of the plurality of drill pipes, drill collars, tools, and the drill bit. The drill string 102 is hollow such that fluid may be pumped downhole through the drill string 102 and circulated back up the annulus (i.e., the void between the drill string and the casing/open hole).

In an embodiment, the drill string 102 is composed a plurality of drill pipes strung together and attached end-to-end. Each of the plurality of drill pipes is hollow. In an embodiment, the drill pipes are thin walled and constructed of steel or other alloy piping that is commonly used in drilling rigs. The drill string 102 is configured to permit drilling fluid to be pumped downhole through a bit and then back up through an annulus. The drill string 102 may come in any suitable size or diameter. The drill string 102 is designed to transfer drilling force through the plurality of individual drill pipes for a combined length that may exceed several miles down into the Earth's crust. The drill string 102 is designed to resist pressure differentials between the interior cavity or each of the drill pipes and the exterior space. Particularly with respect to individual drill pipes that are located deeper in the drill string 102, the drill pipe is designed to suspend the total weight of deeper components. Such drill pipes may be constructed of tempered steel tubes that can be exceptionally costly. Each drill pipe making up the drill string 102 includes a long tubular section with a specified outside diameter. At each end of the drill pipe tubular, there is a larger diameter portion referred to as a tool joint. One end of a drill pipe includes a male pin connection while the other end has a female box connection. The tool joint connections are threaded and allow for the mating of each drill pipe segment to the next segment.

The drill string 102, and/or individual drill pipes making up the drill string 102, may be inspected on site or off location. Ultrasonic testing and modified instruments are utilized at inspection sites to identify detects from metal fatigue and to prevent fracture of the drill string 102 during future well boring. The drill string 102 includes both the plurality of individual drill pipes and a bottom hole assembly (BHA), which includes a tubular portion closest to the bit. The BHA may be constructed of thicker walled heavy weight drill pipe and drill collars that have a larger outside diameter and provide weight to the drill bit and stiffness to the drilling assembly. Other BHA components may include a mud motor, a measurement while drilling apparatus, one or more stabilizers, and various specialty downhole tools.

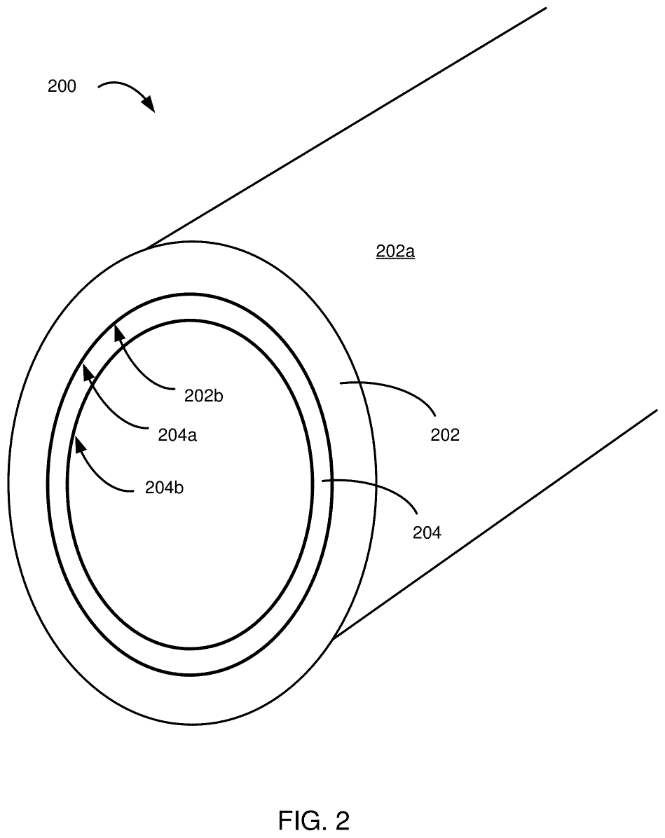

FIG. 2 illustrates a perspective view of a drill pipe 200. The drill pipe includes an exterior wall 202 and an internal protective coating (IPC) 204. The exterior wall 202 has an exterior surface 202a and an interior surface 202b. The internal protective coating 204 has an exterior surface 204a and an interior surface 204b. The interior surface 202b of the external wall 202 and the exterior surface 204a of the internal protective coating 204 may make contact or may form a small gap or cavity. The space between the external wall 202 and the internal protective coating 204 may enable a surface wave to travel the length of the drill pipe 200. The surface wave travels the length of the drill pipe 200 by way of the natural phenomena of “Skin Effect” at high frequencies where the electromagnetic signal travels within the dielectric gap of two adjacent bodies (i.e., the external wall 202 and the internal protective coating 204) with different dielectric characteristics without the need of an electrical return path.

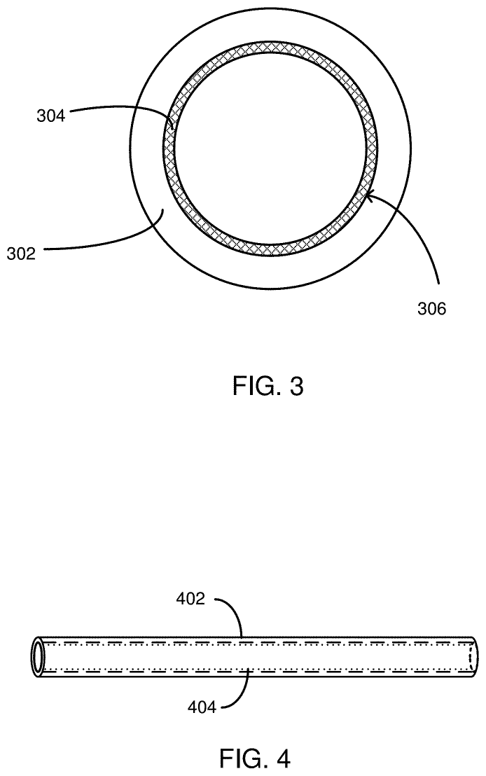

FIG. 3 illustrates a front cross-section view of a drill pipe illustrating an internal protective coating (IPC) 304 which may be used in tubular components of a drill string 102, such as a drill pipe. The wall 302 of the drill pipe is lined with the IPC 304. The dielectric interface 306 between the wall 302 and IPC 304 may be used for transmission of data as discussed above.

FIG. 4 illustrates a side view of a drill pipe 402 with an IPC 404 extending along a length of an interior surface of the drill pipe 402. A signal may be propagated through the dielectric gap between the pipe wall and the IPC 404. In one embodiment, a thin conductor may be embedded between the pipe wall and the IPC 404.

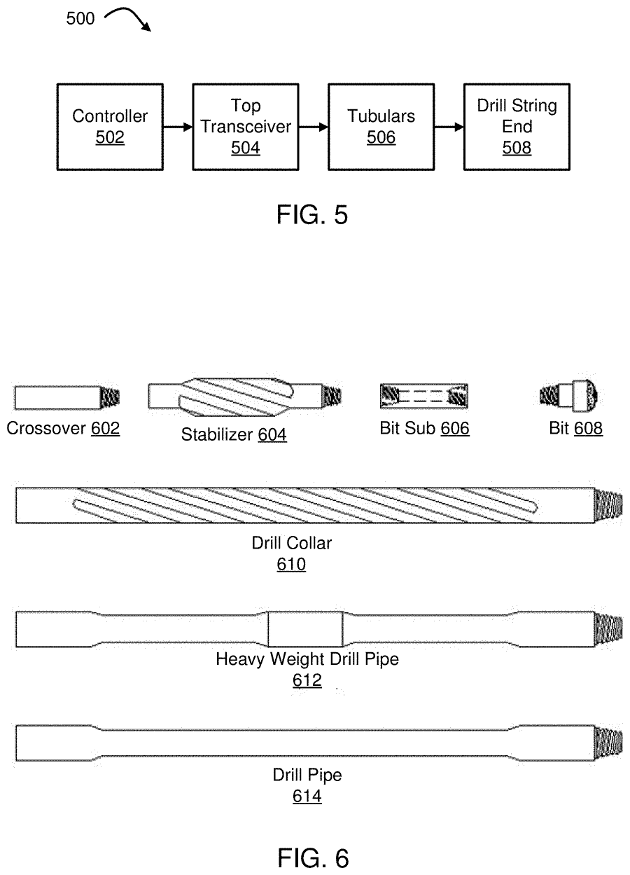

FIG. 5 illustrates a system 500 for drill string communication, according to one embodiment. As referred to herein, a drill string may include a plurality of drill pipes or tubulars strung together. The plurality of drill pipes or tubulars in the drill string may be connected electrically in series or may have electrical connections in parallel. The system 500 includes a controller 502, a top transceiver 504, one or more tubulars 506, and a drill string end 508 (such as a drilling bit).

The controller 502 may manage operation of a drill string or manage communication by the top transceiver between downhole transceivers. The controller 502 may include a processor, memory, input devices, and/or a display for allowing for human operation or monitoring of the drill string. The top transceiver 504 may include a transceiver at or near a top of the exit location of a drill string. The one or more tubulars 506 may include pipe or other accessories within the drill string. Each of the one or more tubulars 506 may be coupled to each other for flow of mud. Additionally, each of the one or more tubulars 506 may act as a waveguide for communication of data between the top transceiver 504 and/or one or more downhole transceivers. Some of the tubulars 506 may further include a downhole transceiver. For example, transceivers may only be needed every 100, 200, 300 or other number of pipes or joints. For example, a transceiver may not be needed at each pipe because the signal loss across the joints may be low enough that signals may be propagated and received across multiple pipe lengths and/or joints. The drill string end 508 may include a bit or other tip for drilling. The drill string end 508 may include a transceiver for receiving information from and/or transmitting information to the top transceiver 504.

FIG. 6 illustrates example drill string components (e.g., tubulars or drill string ends) that may be used. For example, the tubulars 506 of FIG. 5 may include any of a drill pipe 614, heavy weight drill pipe 612, drill collar 610, crossover 602, stabilizer 604, bit sub 606, or bit 608. The drill string end 508 of FIG. 5 may include a bit 608 or another drill string end. Many, if not most, of the string components (i.e., tubulars) have an IPC to protect the internal wall from corrosion and abrasion during drilling operations. That IPC is typically made of a dielectric material such as a hard polymer, ceramic, or an epoxy.

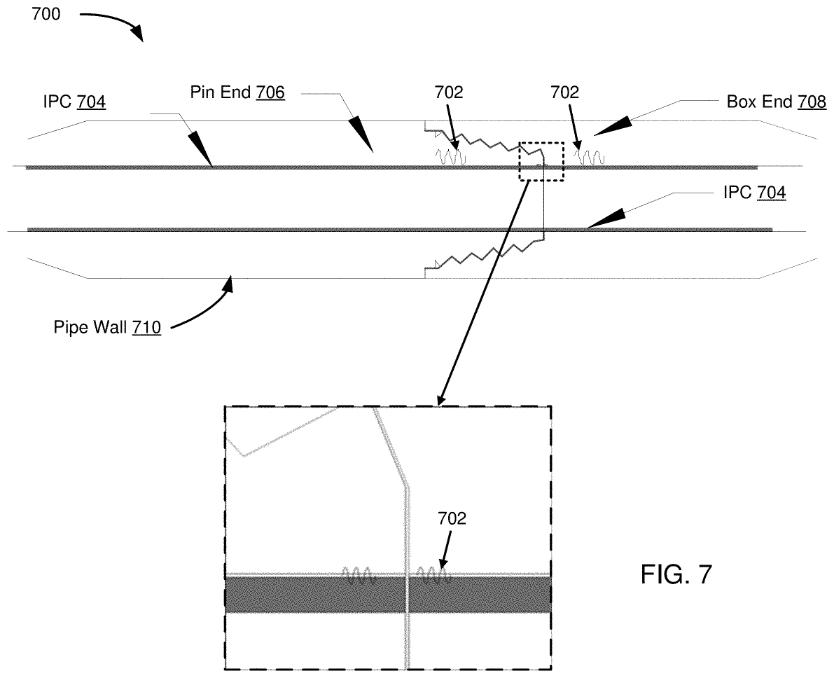

FIG. 7 illustrates an interface 700 between a pin end 706 of first pipe and a box end 708 of second pipe with signals traveling between a pipe wall 710 and IPC 704. For example, the signals may be within surface waves 702 that propagate between the dielectric difference between the pipe wall 710 and the IPC 704 itself. In this case, the IPC 704 serves as the waveguide and when pipes are coupled to each other by screwing them together, the wave guides align and extend to the next section, as illustrated. Alternatively, the use of a coupler ensures that a dielectric path remains un-interrupted. This illustrates one embodiment where signals and waves are transmitted in the pipe IPC interface 700. In some embodiments, this may allow for the use of many existing drill pipes in an unmodified state for acting as a waveguide for signals.

In an embodiment, an insulated conductor is embedded within the inside wall of a drill pipe or tubular. The insulated conductor may be embedded within a new or used drill pipe or tubular. This implementation may be particularly beneficial in applications where the drill pipe or tubular does not have adequate insulating coating.

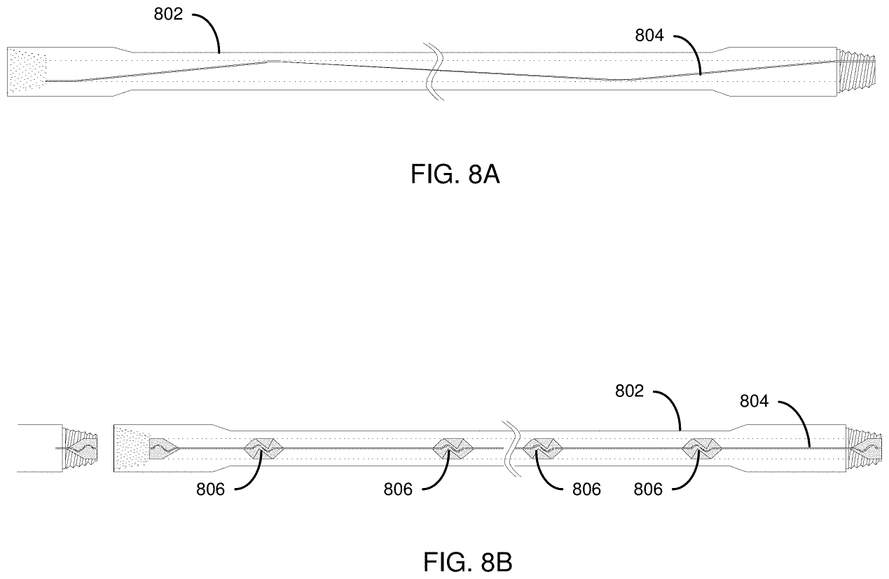

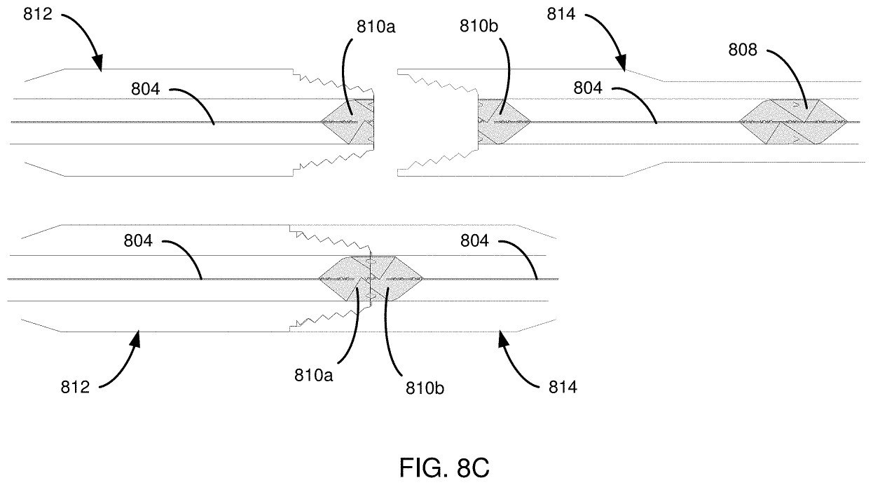

FIG. 8A illustrates a drill pipe 802 with an embedded waveguide 804 (may alternatively be referred to as a conductor). The waveguide 804 (either insulated or not) may be placed on or within the IPC during the manufacturing or refurbishing process. This waveguide 804 can be a cable or a plated copper strip on the inside wall of the pipe and/or an outside wall of the IPC. The physical path of the waveguide 804 can be a spiral, or a series of spirals, or other desired mechanical designs to provide needed electrical and communications characteristics and to allow for mechanical strain relief during bending or stretching of the pipe. Because the waveguide 804 is within the pipe but not within the IPC, reduced risk of damage to the conductor or interference with mud flow is achieved over embodiments where cables are internal to the pipe.

FIG. 8B illustrates a side cross-sectional view of a drill pipe 802 with an embedded waveguide 804. As illustrated in FIG. 8B, the waveguide 804 may be secured in place by attaching the waveguide 804 to a coupler 806 as illustrated in FIG. 8B. The coupler 806 may be a spring metal sheet and may include characteristics as tempered blue spring steel or similar metal spring characteristics. The coupler 806 may be folded such that it may be slid into the drill pipe 802 cavity. Once the coupler 806 is located within the cavity of the drill pipe 802, the coupler 806 may naturally conform to the shape of the inside wall of the drill pipe 802 and provide anchoring to the waveguide 804 within minimal obstruction of flow. Clamping ears on the coupler 806 may provide strain relief against vertical and lateral forces. Further, the coupler 806 may act as a signal “launcher” as needed.

FIG. 8C illustrates side cross-sectional views of a first drill pipe 812 and a second drill pipe 814. The first drill pipe 812 includes a first coupler ending 810a (may alternatively be referred to as a first waveguide coupler). The second drill pipe 814 includes a second coupler ending 810b (may alternatively be referred to as a second waveguide coupler). The coupler endings 810a, 810b may be cut in the shape of a three-dimensional cone to act as a waveguide or conductor when coupled together. The path of the waveguide 804 may be physically interrupted in every connection, but because of the waveguides 804 of the first drill pipe 812 and the second drill pipe 814 being aligned, this interruption represents a small loss to the system. The low loss is due to the nature of electromagnetic waves tending to travel in a straight direction when a waveguide 804 is interrupted. The couplers (also referred to as the waveguide couplers) are configured to couple or align the surface wave travelling down a drill string. Alternatively, the use of a collapsible coupler ensures that a dielectric path remains un-interrupted. In an embodiment, the surface wave travels within a gap between the internal protective coating an interior side of the exterior wall of a drill pipe.

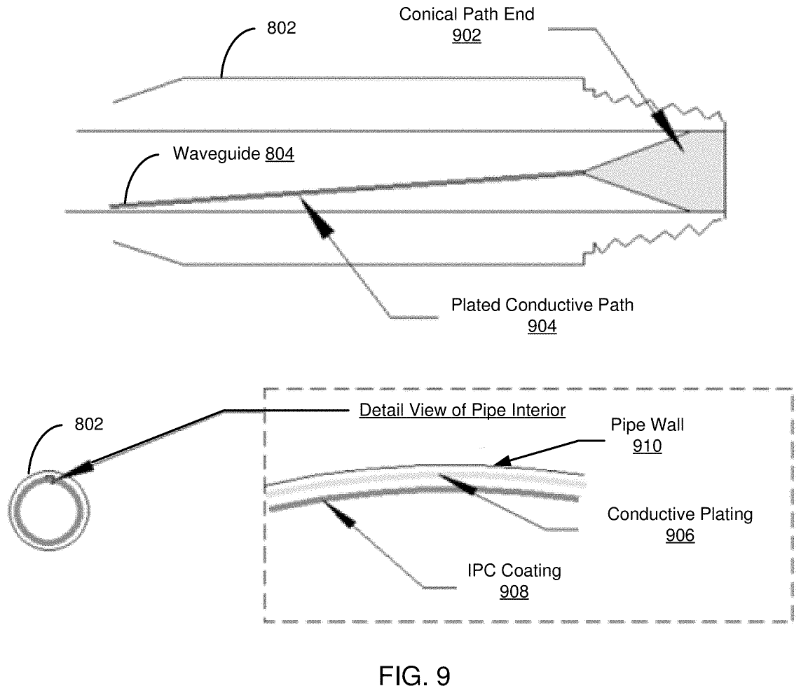

FIG. 9 illustrates an end of the drill pipe 802 of FIG. 8 to illustrate how the waveguide 804 can communicate a signal to a subsequent pipe. FIG. 9 illustrates a conical path end 902 (may alternatively be referred to as a waveguide coupler) of a drill pipe 802 that enables the drill pipe 802 to be matched with a different pipe such that it will maintain an electrical or conductive connection with the waveguide 804. As illustrated, the waveguide 804 takes a plated conductive path 904 and ends with a conical path end 902. The detail view of the pipe interior illustrates the conductive plating 906 of the wave guide 804 and the IPC coating 908 that coats the waveguide 804. The conductive plating 906 may run adjacent to the pipe wall 910 as illustrated in the detail view of the pipe interior.

Specifically, as illustrated in FIG. 9, the ending (i.e., at the end of the drill pipe 802 where the drill pipe 802 might match with a different pipe) of the waveguide 804 has a conical path end 902. The conical path end 902 is the shape of a three-dimensional cone such that the full outside circumference of the IPC coating 908 matches with the waveguide 804 of a subsequent pipe when they are coupled together. In one embodiment, if the waveguide 804 at the end covers more than about ½ of the circumference, electrical or electromagnetic communication with the next pipe may be established. For example, the full circumference of the gap at the end of the drill pipe may be conductive plating such that the waveguide 804 of different pipes meet regardless of the respective rotation of the pipes. In one embodiment, the cone may be an insert or a plated surface between the IPC and the wall of a drill pipe. The wave path may be physically interrupted resulting in a loss at every connection, but because of the waveguide 804 being aligned, this interruption represents a small loss to the whole system.

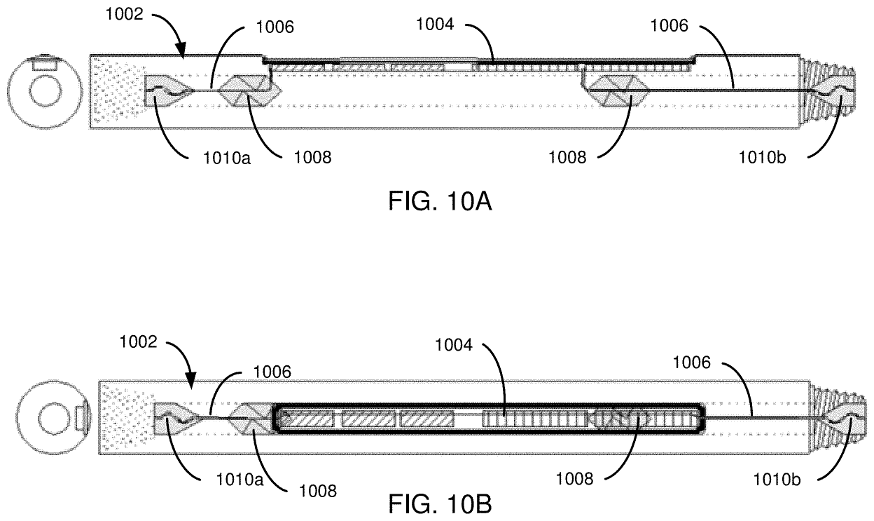

FIG. 10A depicts a side cross-sectional view of a drill pipe 1002 with a built-in transceiver 1004 and FIG. 10B depicts an aerial cross-sectional view of the drill pipe 1002 with the built-in transceiver 1004. The drill pipe 1002 includes couplers 1008 configured for anchoring the waveguide within the interior of the drill pipe 1002 (see 808 in FIG. 8C). The drill pipe 1002 further includes a first coupler ending 1010a at a first end of the drill pipe 1002 and a second coupler ending 1010b at a second end of the drill pipe 1002 (see 810a and 810b).

In one embodiment, drill string components that include transceivers may be used every N components. For example, N may be the number of joints, pipes or accessories that still results in an acceptable signal loss for transmitted signals. Thus, not every drill pipe or drill string component is necessarily required to include a transceiver. In one embodiment, the transceiver 1004 is mounted inside a housing that provides the same inside diameter and outside diameter as that of the tool connections of the pipe, as much as possible. The housing contains the electronic circuits required for receiving and transmitting signals, any other digital or analog interfacing circuity such as tuners, amplifiers, modulators, demodulators, digital processing, sensor devices, space and coupling connections for other third-party instrumentation devices, etc. as well as any batteries that provide power to the components. The length of the transceiver housing can be as short as permitted by the make-up equipment at the rig (e.g., typically 6 feet in some embodiments).

In one embodiment, the transceiver housing uses the same method as other pipes in the drill string (e.g., the IPC pipe interface 704 of FIG. 7 or the waveguide 804 of FIGS. 8 and 9). In one embodiment, the pipe 1002 may use an embedded wire for receiving/collecting a signal from a neighboring pipe or tubular member. The wire can be routed from the internal wall (e.g., between the IPC 908 and pipe wall 910) to the electronics of the transceiver 1004 in the housing through one or more small boreholes 1006, where the appropriate circuitry would process the signal.

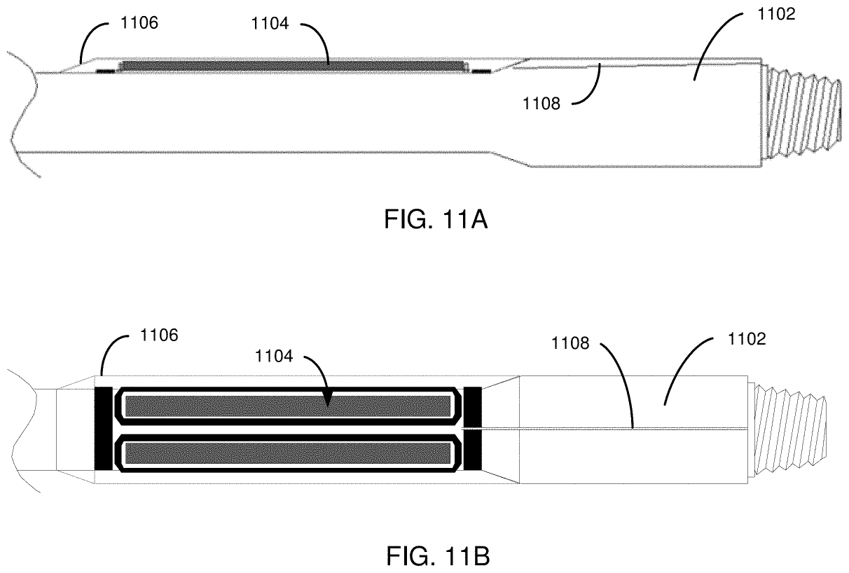

FIG. 11A illustrates a side view of a drill pipe 1102 and FIG. 11B illustrates an aerial cross-sectional view of the drill pipe 1102. The drill pipe 1102 includes a transceiver 1104 and a transceiver housing 1106 that can be clamped to the outside of the drill pipe 1102, resulting in an increased diameter of at least a portion of the drill pipe 1102. In one embodiment, the increased outside diameter is still substantially the same or less than the largest outside diameter of the pipe (e.g., the diameter near the ends). For example, where size permits, the transceiver housing 1106 can be in the form of a clamp that can be mounted and wrapped around the pipe pin end itself and secured with suitable fasteners and sealing methods. Once again, a small borehole 1108 may provide electrical or electromagnetic communication between an interior wall of the pipe and the transceiver 1104.

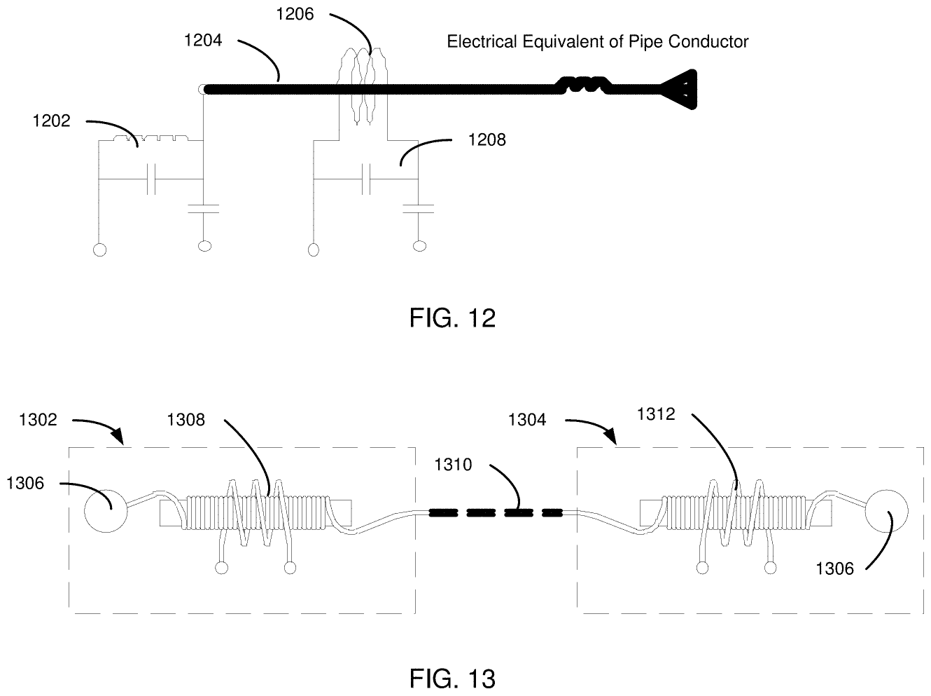

FIG. 12 illustrates a simplified equivalent tuned circuit for transmitting information using the pipe or conductor as a signal medium or waveguide. The transceiver's receiving and transmitting tank circuits 1202, 1208 can be coupled to the conductor 1204 by wave launchers. A simplified example of possible signal injection 1206 and pick is illustrated in FIG. 12, but other methods such as surface wave launchers, impedance matching, phase difference between the wire and the surrounding pipe, near field effect detection, etc. may be used.

FIG. 13 illustrates how information or power may be transmitted between transmitters located on different pipes and/or with multiple intervening pipes. Specifically, a transmitting section 1302 of the transceiver of a first pipe outputs its signal to the wire by wave launchers to a receiving section 1304 of a second pipe. The transmitting section 1302 of the first pipe includes a dummy load 1306 and a transmitter coil 1308. A waveguide 1310 throughout the string connects pipe to pipe. The receiver section 1304 of the second pipe includes a receiver coil 1312 and dummy load 1306.

Because pipes are connected in series to each other, the conductive path of interest is extended by the length of each additional pipe throughout the length of the conductive path 1310 of the string. The transmission of signal is achieved by capturing the surface waves on the conductive path 1310 that acts in effect as a wave guide. When transmitting power, Suitable termination would be applied at the ends of the conductive path 1310 (see 1308 and 1312) to prevent radiation and reflection of the radio frequency signal. The use of multiple tuned circuits enables the possibility to transmit multiple bands or to separate the transmission direction from up or down the conductive path 1310 of the string. One of the possibilities is to use one or many special tuned circuits to provide a charging potential to the batteries in the transceiver housing or power to motors downhole. Thus, a first set of tuned circuits may be used for communication into the hole, a second set of tuned circuits may be used for communication out of the hole, and a third set of tuned circuits may be used for transmitting power to electrical loads or components (e.g., batteries or motors). Additional or fewer sets of tuned circuits may be used for any other purposes. In one embodiment, these tuned circuits may use the same waveguide or conductor for these multiple communication/powering purposes each independent of each other.

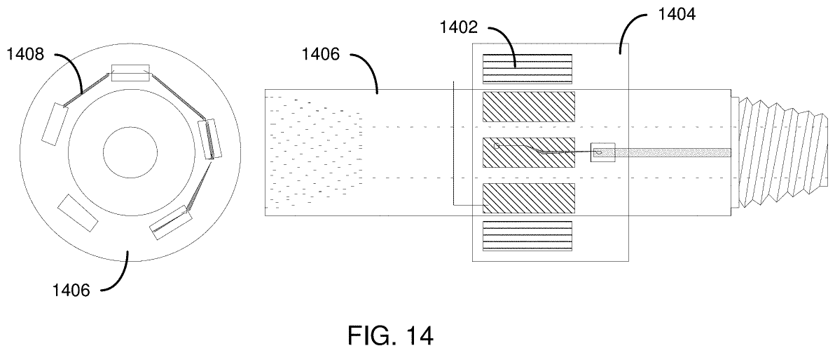

FIG. 14 illustrates a transceiver 1402 to be used at the top of a drill string (i.e., top transceiver 504). The transceiver 1402 at the top of the string can be mechanically connected to the top-drive of the string. It may have a different layout of its components and they would be inside an enclosure 1404 attached to the outside perimeter of a short pipe 1406. It will serve as a downhole network entry point controller . It can also contain a wireless transmitter to communicate to a remote panel (e.g., controller 502) where the network signals can be processed and interpreted as desired by a master network controller and its appropriate controlling software to provide a suitable interface and command console. The command console may be provided to third parties and may be configured for monitoring network performance including data consumption information.

The power to this top transceiver can be provided by re-chargeable batteries, directly, or by inductive field. In an embodiment, the top transceiver (or any other transceivers) are powered by a hard-wired connection that provides charging energy to transceivers downhole or to other devices that may require recharging while downhole, including motors. The antenna 1408 to communicate to remote external devices (e.g., controller 502) can be a half loop that arcs around the enclosure 1404 to provide a constant signal during rotation of the string.

According to one embodiment, from the signal perspective, the insertion loss in every joint connection can be less than 0.2 db. With a transceiver that can process a −60-db. signal, a transceiver would be placed at a count of about every 300 joints. Using Range-2 pipe with a nominal length of 31.5 feet, the distance between transceivers would be 9450 feet—compared to the typical spacing of about 1500 feet for wired pipe using a coax cable and inductive couplers.

As discussed previously, the transceivers may use different wireless bands for different purposes. The following are example wireless spectrum bands, some of which may be used for downhole communication: the very low frequency (VLF) band from 3 kHz to 20 kHz (wavelength of 100 km to 10 km) which is sometimes used for maritime radio and navigation; the low frequency (LF) band from 30 kHz to 300 kHz (wavelength of 10 km to 1 km)which is sometimes used for maritime radio and navigation; the medium frequency (MF) band from 300 kHz to 3 MHz (wavelength of 1 km to 100 m) which is sometimes used for AM radio, aviation radio, and navigation; the high frequency (HF) band from 3 MHz to 30 MHz (wavelength of 100 meters (m) to 10 m) which is sometimes used for shortwave radio; the very high frequency (VHF) band from 30 MHz to 300 MHz (wavelength of 10 m to 1 m) which is sometimes used for VHF television and FM radio; the ultra-high frequency (UHF) band from 300 MHz to 3 GHz (wavelength from 1 m to 10 cm) which is sometimes used for UHF television, mobile phones, GPS, Wi-Fi, and 4G communication; the super high frequency (SHF) band from 3 GHz to 30 GHz (wavelength from 10 cm to 1 cm) which is sometimes used for satellite communications and Wi-Fi; and the extremely high frequency (EHF) band from 30 GHz to 300 GHz (wavelength from 1 cm to 1 mm) which is sometimes used for radio astronomy and satellite communications.

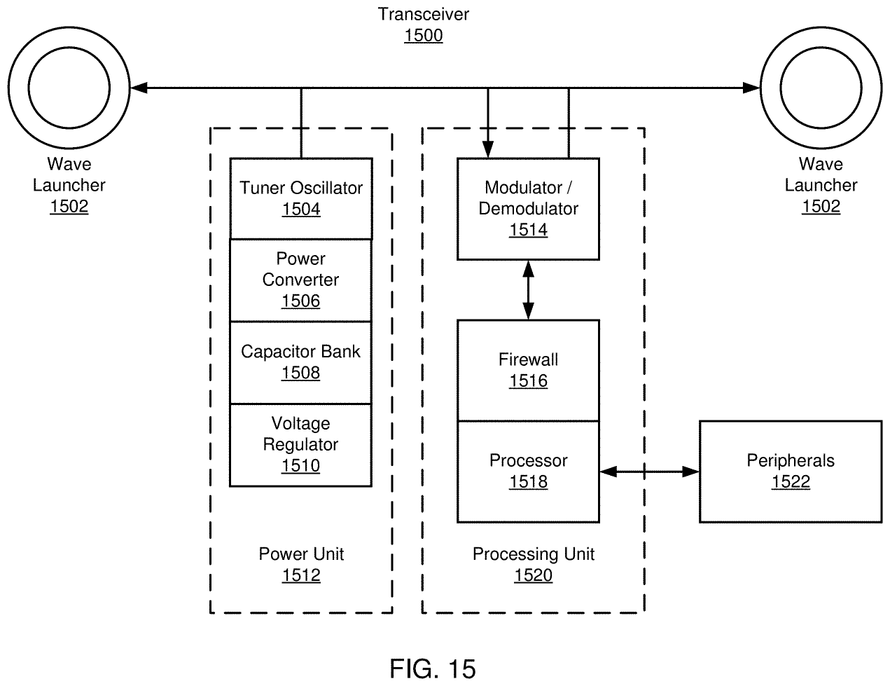

FIG. 15 illustrates a block diagram of a transceiver 1500. The transceiver includes a wave launcher 1502 which may alternatively be referred to as a detector. The wave launchers couple or decouple the signals from the waveguide. The transceiver includes a power unit 1512 and the power unit includes a tuner oscillator 1504, a power converter 1506, a capacitor bank 1508, and a voltage regulator 1510. The tuner oscillator 1504 gets excited and becomes resonant at specific frequencies providing resonant energy to the power converter 1506. The power converter regulates that energy to provide charging current to the capacitor bank 1508. The capacitor bank stores the energy and provides it as needed to the voltage regulator 1510 which provides power to the processing unit 1502. The transceiver 1500 includes a processing unit 1520. The processing unit 1520 includes a modulator/demodulator 1514 which, via the launchers 1502, extracts or embeds the information into a carrier signal suitable for waveguide transmission, a firewall 1516 (may alternatively be referred to as a network hub) which provides secure bidirectional network communication , and a processor 1518 which interprets the communication data, acts or responds with information about the processing unit itself or with information from interfacing with peripherals 1522 such as third-party instrumentation.

The transceiver 1500 may utilize high encryption protocols to provide network access and security. Each transceiver 1500 may have its own pressure, temperature, and azimuth sensors but may further offer an interface to other instrumentation components desired by other third parties.

The communication may be classified as 3G or 4G. In one embodiment, transceivers or processors for transmitting or processing signals may include off-the-shelf 3G, 4G, 5G, Wi-Fi, or any other wireless communication standard. The 3G wireless communication standard may have a frequency band of 1.8 to 2.5 GHz and a bandwidth of 5-20 MHz. The data rate for 3G communications may be up to 2 Mbps and access may be achieved by way of wideband CDMA (Code Division Multiple Access). The 4G wireless communication standard may have a frequency band of 2 to 8 GHz and a bandwidth of 5-20 MHz. The data rate may be up to 20 Mbps or more and access may be achieved by way of CDMA or OFDM (Orthogonal Frequency-Division Multiplexing).

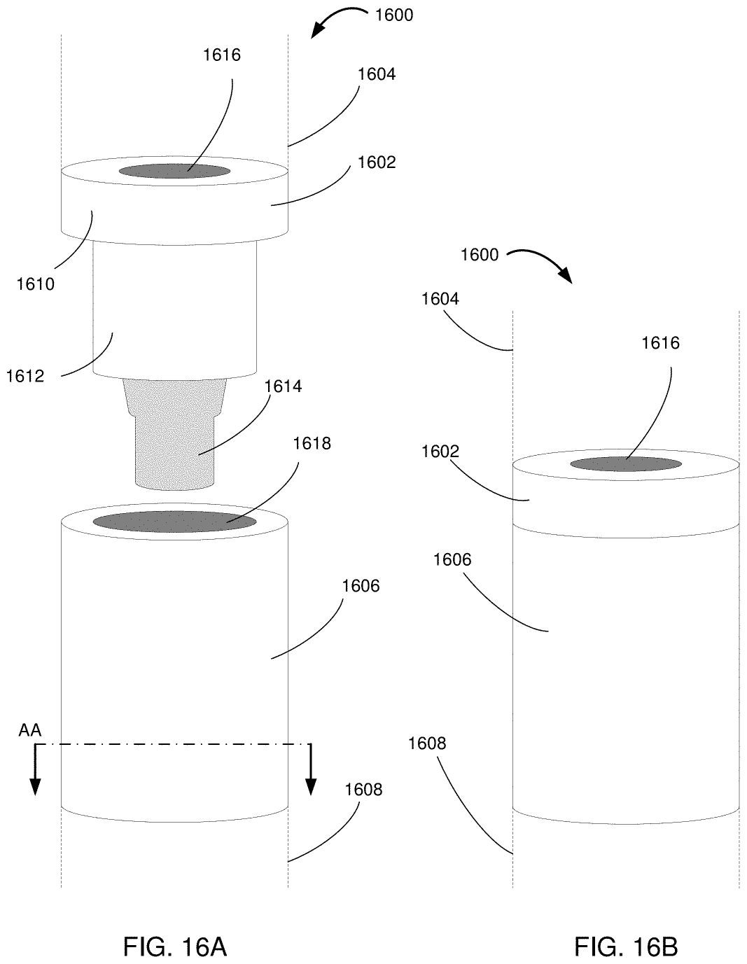

FIGS. 16A-26C illustrate additional embodiments of drill pipe connections for connecting lengths of drill pipe end-to-end to form a pipe string. The pipe string includes a dielectric wave path along the length of the pipe string, which propagates waves and signals along the length of the pipe string by way of the natural phenomena of “Skin Effect.” In the Skin Effect, an electromagnetic signal travels within the gap of two adjacent bodies with different dielectric characteristics without the need of an electrical return path. Embodiments described below include dielectric internal protective coatings along a length of the pipe string and flexible sleeves at pipe end connections that connect the internal protective coating of a first drill pipe to the internal protective coating of a second drill pipe connected to the first drill pipe. The embodiments of drill pipe connections will be discussed below with reference to FIGS. 16A-26C.

FIGS. 16A and 16B illustrate a perspective view of a drill pipe connection 1600 according to one embodiment. FIG. 16A illustrates drill pipe connection 1600 in a separated state. As illustrated, drill pipe connection 1600 may include a male connection end 1602 of a first drill pipe 1604 and a female connection end 1606 of a second drill pipe 1608. For convenience, first drill pipe 1604 and second drill pipe 1608 are illustrated as dashed lines extending from the connection ends.

As shown, drill pipe connection 1600, male connection end 1602, and female connection end 1606 may be substantially cylindrically shaped pipes both having an exterior wall and an interior surface. However, drill pipe connection 1600 is not limited to this shape. Any suitable shape for drill pipe applications may be used. Male connection end 1602 may include a large diameter section 1610 and a small diameter section 1612 with a smaller diameter than the large diameter section 1610, and a collapsible flexible sleeve 1614 that is seated and held in the small diameter section 1612. Male connection end 1602 may include an exterior wall on an outside of the male connection end 1602 and may include a hollow cavity 1616 that accommodates the flow of fluids commonly pumped through drill pipe strings, such as mud, water, or other fluids.

Female connection end 1606 may be a hollow drill pipe including an exterior wall and a hollow cavity 1618 to accommodate the flow of fluids, such as mud, water, and/or other fluids therein. Additionally, hollow cavity 1618 may receive flexible sleeve 1614 and small diameter section 1612 of male connection end 1602 when the female connection end 1606 and male connection end 1602 of drill pipe connection 1600 are connected together (illustrated in FIG. 16B).

FIG. 16B illustrates drill pipe connection 1600 in a connected state where male connection end 1602 is disposed within female connection end 1606. In the connected state, male connection end 1602 and female connection end 1606 may be connected and fixed together by any known method, such as clamping, fasteners, adhesive, and/or by any mechanical, chemical, or other means.

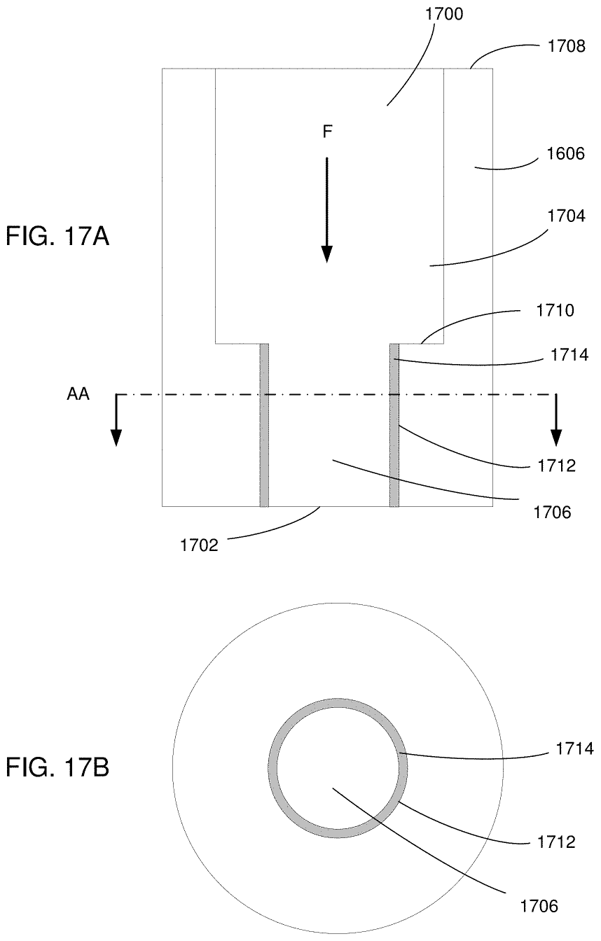

FIG. 17A illustrates an internal cross-sectional view of female connection end 1606 cut down a diameter of female connection end 1606 and viewed from a side, according to at least an embodiment. In female connection end 1606, openings 1700 and 1702 and large diameter hollow cavity 1704 and small diameter hollow cavity 1706 may be provided for accommodating the flow of fluids through female connection end 1606. Arrow F indicates a direction of fluid flow in female connection end 1606. Large diameter hollow cavity 1704 is configured to receive small diameter section 1612 of male connection end 1602. Small diameter hollow cavity 1706 is configured to accommodate flexible sleeve 1614 when flexible sleeve 1614 is extended out of male connection end 1602. Female connection end 1606 may further include an upper surface 1708 and a support surface 1710 that support male connection end 1602 when the two connection ends are interfaced with each other.

Female connection end 1606 may further comprise an inner surface 1712 facing inward around a full diameter of the interior of female connection end 1606. As illustrated in FIG. 17A, an internal protective coating 1714 may be disposed on the inner surface 1712 of female connection end 1606. FIG. 17B shows a cross-sectional view of female connection end 1606 taken along line AA and viewed from top. As illustrated, inner surface 1712 of hollow cavity 1706 may be covered with internal protective coating 1714 around the entire circumference of inner surface 1712.

As described elsewhere in this disclosure, waves and signals may propagate along a dielectric difference between internal protective coating 1714 and inner surface 1712 by “Skin Effect.” Internal protective coating 1714 may be similar to any other internal protective coatings and wave propagating elements described elsewhere in this disclosure. Furthermore, a metal waveguide may be disposed between internal protective coating 1714 and inner surface 1712. The disclosure of drill pipe connection 1600 may be modified and/or combined with any of the other embodiments described herein. Connection between the internal protective coating 1714 of female connection end 1606 and an internal protective coating of male connection end 1602 is accomplished by collapsible flexible sleeve 1614, which is described in detail below.

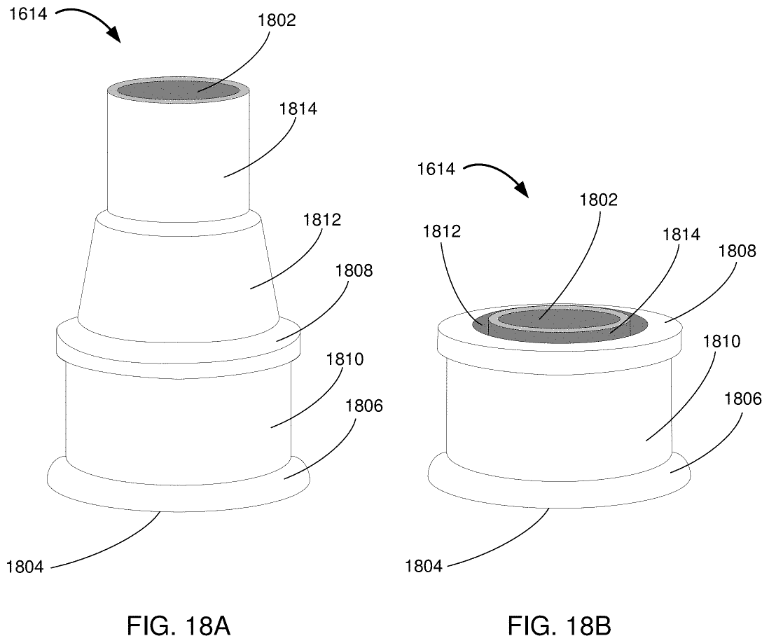

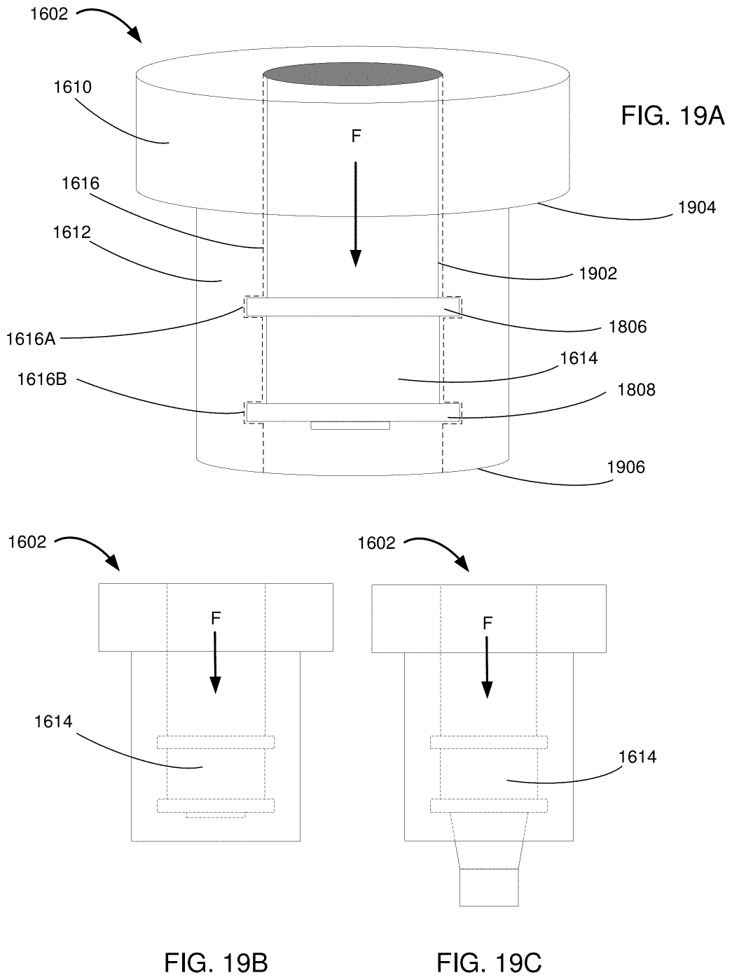

FIGS. 18A and 18B illustrate perspective views of flexible sleeve 1614 in different states. FIG. 18A illustrates flexible sleeve 1614 in an extended state. As shown, flexible sleeve 1614 may be hollow, substantially cylindrical in shape, and include openings 1802 and 1804 to facilitate the flow of fluids therethrough. Flexible sleeve 1614 may further include ring ridges 1806 and 1808 that extend outward from flexible sleeve 1614 and continue around an outer circumference of flexible sleeve 1614. Ring ridges 1806 and 1808 for seating flexible sleeve 1614 within male connection end 1602, which will be described with reference to FIG. 19A. Flexible sleeve 1614 is not limited to the shape disclosed herein and may be any suitable shape for drill pipe applications.

Flexible sleeve 1614 may be collapsible. For example, as shown in FIG. 18A, flexible sleeve 1614 may include a bottom portion 1810, a middle portion 1812, and an upper portion 1814, as shown in the fully extended configuration of flexible sleeve 1614 shown in FIG. 18A. Force exerted on extended flexible sleeve 1614 may cause flexible sleeve to telescope inward, or collapse to a smaller collapsed configuration, as shown in FIG. 18B. In collapsing, middle portion 1812 of flexible sleeve 1614 flexes downward and moves inward inside of bottom portion 1810. Similarly, as middle portion 1812 flexes downward and collapses, upper portion 1814 is also disposed within bottom portion 1810. Accordingly, the upper 1814, middle 1812, and bottom 1810 portions, in the collapsed state of flexible sleeve 1614, form three concentric rings with the upper portion closest to the middle of flexible sleeve 1614, the bottom portion 1810 being the outermost ring, and the middle portion 1812 being between the upper portion 1814 and bottom portion 1810. It is to be appreciated that flexible sleeve 1614 may alternate between the extended (FIG. 18A) and collapsed (FIG. 18B) states according to current desires and needs of a user.

Flexible sleeve 1614 may be made of a material exhibiting dielectric properties that facilitate propagation of waves via Skin Effect. Flexible sleeve 1614 may be made of any appropriate material described elsewhere in this disclosure. Furthermore, flexible sleeve 1614 may be an elastomer material with good stretching, strength, and elastic properties. For example, flexible sleeve 1614 may be made of elastomers such as Hydrogenated nitrile (HNBR), hydrogenated acrylonitrile butadiene, and fluoroelastomers, such as vinylidene fluoride and propylene. This list is not exhaustive, those skilled in the art will appreciate that many different types of elastomers may be used for flexible sleeve 1614 in order to meet desired elasticity and wave propagation properties.

FIG. 19A illustrates of an internal view of male connection end 1602 and flexible sleeve 1614 disposed therein. As illustrated, hollow cavity 1616 of male connection end 1602, illustrated in FIG. 19A with dashed lines, may include ring grooves 1616A and 1616B. Ring grooves 1616A and 1616B may be formed and extend around an entire circumference of an inner surface of hollow cavity 1616 and inner surface of male connection end 1602. Flexible sleeve 1614 may be disposed within hollow cavity 1616 of male connection end 1602. Ring ridges 1806 and 1808 of flexible sleeve 1614, flex and fit into ring grooves 1616A and 1616B. Accordingly, flexible sleeve 1614 may be held in place by ring ridges 1806 and 1808 fitting snugly into grooves 1616A and 1616B.

Although the number of ring ridges and ring grooves shown herein is two, the disclosure is not so limited. The flexible sleeve may be formed to include zero, one, or a plurality of ring ridges. Similarly, any number of ring grooves may be formed into hollow cavity 1616 of male connection end 1602 (e.g., zero, one, or a plurality) in order to receive the corresponding ring ridges of the flexible sleeve.

Male connection end 1602 may further include an internal protective coating 1902 extending along a length of the inner surface of hollow cavity 1616 formed in male connection end 1602. The internal protective coating 1902 may be an extension of flexible sleeve 1614, may be directly attached to or integrally formed with flexible sleeve 1614, or may be in contact with flexible sleeve to form a waveguide path through a length of male connection end 1602.

As shown in FIG. 19A, male connection end 1602 may include a large diameter section 1610 and a small diameter section 1612. Male connection end 1602 may include a hollow cavity 1616 that accommodates the flow of fluids pumped through drill pipe strings, such as mud, water, or other fluids. Furthermore, large diameter section 1610 may include a lower surface 1904 that engages with a corresponding surface of female connection end 1606. Small diameter section 1612 may include a lower surface 1906 that engages with a corresponding surface of female connection end 1606.

FIGS. 19B and 19C illustrate different states of flexible sleeve 1614 when the flexible sleeve is seated inside hollow cavity 1616. FIG. 19B illustrates flexible sleeve 1614 in a collapsed state. FIG. 19C illustrates flexible sleeve 1614 in an extended state. Flexible sleeve 1614 may move between the collapsed and extended by forces exerted on flexible sleeve 1614 within the drill pipe or before installation. For example, flexible sleeve 1614 may be pulled to an extended state before installation. Alternatively, flexible sleeve 1614 may be installed in the collapsed state. When installed in the collapsed state, flow F of mud and/or other fluids through male connection end 1602 may exert significant force on flexible sleeve 1614, thus causing flexible sleeve 1614 to move from the collapsed state (shown in FIG. 19B) to the extended state (shown in FIG. 19C).

Additionally, the elastic nature of elastomers and other materials used to make flexible sleeve 1614 allows the flexible sleeve to expand far beyond its relaxed size in order to fill hollow cavity 1616. For example, under stretching conditions, flexible sleeve may expand to twice its original relaxed size, or even more. The force exerted on flexible sleeve 1614 in common drilling pipe applications, by high flow, high pressure, and high velocity fluids flowing through the sleeve cause an outward expansion of flexible sleeve 1614 in hollow cavity 1616. In such situations, flexible ring ridges 1806 and 1808 exert outward forces on ring grooves 1616A and 1616B, thus firmly holding flexible sleeve 1614 in place within hollow cavity 1616.

In some embodiments, the force expanding flexible sleeve 1614 may be of sufficient strength to create a very strong friction force between flexible sleeve 1614 and inner surface of hollow cavity 1616. The friction force may be strong enough to hold flexible sleeve 1614 in place even without ring ridges 1806 and 1808 and ring grooves 1616A and 1616B. Accordingly, in an alternative embodiment, ring grooves and ring ridges may be omitted. Flexible sleeve 1614 may also be held in place by other means such as adhesives, other protruding features of flexible sleeve 1614 corresponding to similar shaped notches formed in hollow cavity 1616. Although the present embodiment shows rings ridges and ring grooves for holding flexible sleeve 1614 in place, it will be appreciated that any suitable shape of ridges and grooves may be suitable for holding the sleeve in place. Furthermore, the ridges may be formed in the hollow cavity instead of on the sleeve, and grooves may be formed on the sleeve instead of in the hollow cavity. Any of these exemplary methods may be used to hold a sleeve in place in a connection end.

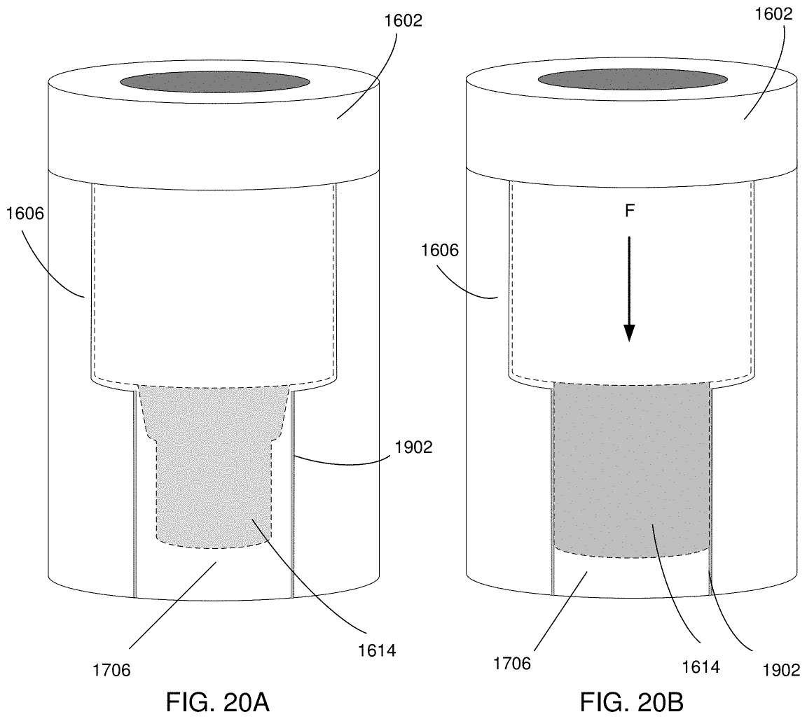

FIGS. 20A and 20B illustrate see-through views of drill pipe connection 1600 in order to illustrate the internal interaction and configuration of male connection end 1602, flexible element 1614, and female connection end 1606 when the connection is assembled. As illustrated, when male connection end 1602 is inserted into female connection end 1606, lower surface 1904 (shown in FIG. 19A) of large diameter section 1610 of male connection end 1602 may contact upper surface 1708 (shown in FIG. 17A) of female connection end 1606. Additionally, lower surface 1906 (shown in FIG. 19A) of small diameter section 1612 of male connection end 1602 may rest on support surface 1710 (shown in FIG. 17A) of female connection end 1606. As further shown, small diameter section 1612 may be entirely surrounded by female connection end 1606.

With male connection end 1602 disposed in female connection end 1606, flexible sleeve 1614, when in an extended position extending out of male connection end 1602, is disposed within small diameter hollow cavity 1706 as shown in FIGS. 20A and 20B. Disposed in small diameter hollow cavity 1706, flexible sleeve 1614 is adjacent to internal protective coating 1902. In the relaxed state (i.e., not stretched), flexible sleeve 1614 may not be large enough to contact internal protective coating 1902 (FIG. 20A). However, as shown in FIG. 20B, flexible sleeve 1614 is shown in a stretched state. Flexible sleeve 1614 stretches to its stretched state in response to high fluid flow F through drill pipe connection 1600. Amounts of pressure and velocity of flow of mud/other fluids exerts force outward on flexible sleeve 1614 and causes it to stretch to fill small diameter hollow cavity 1706. In the stretched state, flexible sleeve 1614 expands and contacts internal protective coating 1902, thereby extending a waveguide/propagation path for waves to travel down hole in a string of pipes that utilize drill pipe connections 1600. Furthermore, the force exerted by flexible sleeve 1614 on internal protective coating 1902 ensures a fluid tight connection between lengths of pipe in the pipe string.

In FIGS. 20A and 20B, liquid pressure and mud flow are relied upon to expand flexible sleeve 1614 against internal protective coating 1902. Initial flow may be strong enough to provide sufficient expansion to cause flexible sleeve 1614 to press against internal protective coating 1902. However, once pressure and flow equalizes, the flexible nature of flexible sleeve 1614 may cause insufficient, intermittent, or only partial contact between flexible sleeve 1614 and internal protective coating 1902. It may be beneficial to provide a hollow expander/member made of a rigid material to ensure consistent contact between flexible sleeve 1614 an internal protective coating 1902.

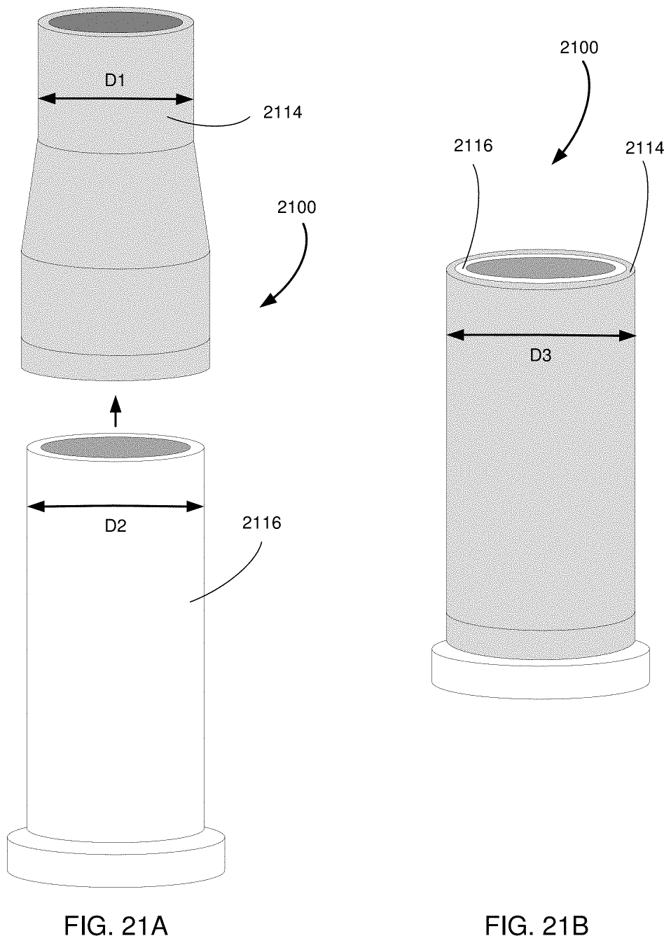

To solve the possible issues just described, FIGS. 21A and 21B illustrate an embodiment of a connection device for creating a dielectric path for propagation of waves down a pipe string. FIGS. 21A and 21B show a collapsible flexible sleeve 2114 and an expander 2116 located at a male connection end 2100. FIGS. 21A and 21B illustrate perspective views of male connection end 2100 including collapsible flexible sleeve 2114 and expander 2116 that may be inserted into the collapsible flexible sleeve 2114 to expand and provide rigidity to collapsible flexible sleeve 2114. Although it is not illustrated in FIGS. 21A and 21B, male connection end 2100 may be disposed in an end of a pipe that may be inserted into a female connection end, similar to the configurations illustrated in FIGS. 20A and 20B. Similar to what is shown in FIGS. 20A and 20B, collapsible flexible sleeve 2114 may be disposed adjacent to an internal protective coating (e.g. internal protective coating 1902 in FIGS. 20A and 20B) and may expand to contact the internal protective coating when male connection end 2100 is inserted into a female connection end (e.g., 1606 in FIGS. 20A and 20B).

In order to ensure more consistent contact between a flexible sleeve 2114 and an internal protective coating, expander 2116 may be inserted into collapsible flexible sleeve 2114 to expand and press flexible sleeve 2114 outward against an adjacent internal protective coating of a pipe string. This may provide more consistent contact between the flexible sleeve and internal protective coating than the configuration of FIGS. 20A and 20B. Instead of relying on mud flow and liquid pressure to expand collapsible flexible sleeve 2114 such as is shown in FIGS. 20A and 20B, a rigid member such as expander 2116 provides for consistent pressure and contact between flexible sleeve 2114 and an internal protective coating.

As illustrated in FIG. 21A, collapsible flexible sleeve 2114 is in a relaxed stated where expander 2116 has not been inserted into collapsible flexible sleeve 2114. In the relaxed state collapsible flexible sleeve 2114 has a first diameter D1, which diameter D1 is of a size that collapsible flexible sleeve 2114 will not be in contact with an internal protective coating of a female connection end of a drill string. In order to expand the diameter D1 to a diameter that ensures contact between collapsible flexible sleeve 2114 and an internal protective coating, expander 2116 having a diameter D2 that is larger than diameter D1 may be inserted into collapsible flexible sleeve 2114 to expand collapsible flexible sleeve 2114 to a larger diameter. This may allow collapsible flexible sleeve 2114 to contact an internal protective coating of a pipe.

FIG. 21B illustrates male connection end 2100 where expander 2116 is disposed within collapsible flexible sleeve 2114 and expands collapsible flexible sleeve 2114 out to a diameter of D3, which is larger than diameters D1 and D2. In FIG. 21B, collapsible flexible sleeve 2114 is in its expanded state with expander 2116 disposed therein. Diameter D3 may be of such a dimension that collapsible flexible sleeve 2114, in the expanded state, is of a sufficient size to reliably contact an internal protective coating in a female connection end of a pipe, similar to how flexible sleeve 1614 contacts internal protective coating 1902 in FIG. 20B.

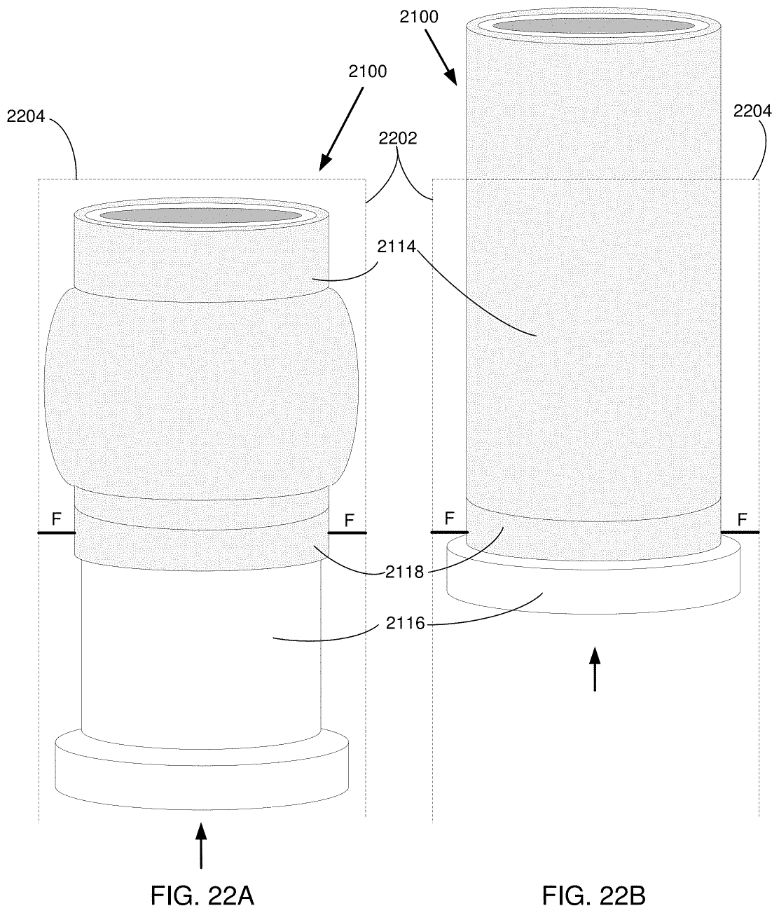

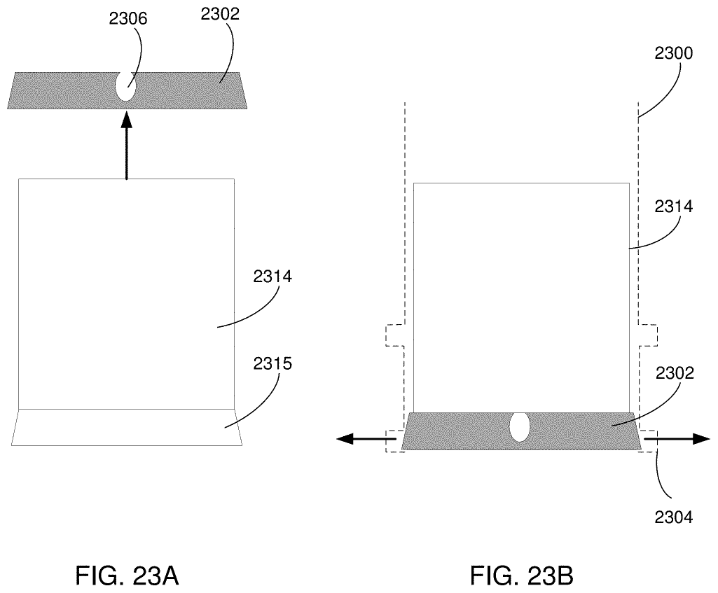

FIGS. 22A and 22B illustrate an embodiment of a connection device for creating a dielectric path for propagation of waves down a pipe string. FIGS. 22A and 22B illustrate the collapsible features of collapsible flexible sleeve 2114 within a drill pipe. The dashed lines in FIGS. 22A and 22B represent an inner cavity of a drill pipe 2202 where flexible sleeve 2114 and expander 2116 are disposed as part of male connection end 2100. FIG. 22A shows a configuration where collapsible flexible sleeve 2114 is in a collapsed position and disposed within the drill pipe 2202. Male connection end may be connected to the inner surface of drill pip 2202 by a fixing element, generically indicated as fixing element F in FIGS. 22A and 22B. The fixing element F may be an adhesive, a clamp (explained later with respect to FIGS. 23A and 23B), mating of ridges with grooves (as shown in FIGS. 19A), or other methods known for fixing an element to an inside of a pipe.

In the configuration shown, collapsible flexible sleeve 2114 is fixed to drill pipe 2202 at lower ring 2118 of collapsible flexible sleeve 2114. Expander 2116 may remain unattached to drill pipe 2202 such that expander 2116 may actuate in and out of end 2204 of drill pipe 2202. Collapsible flexible sleeve 2114 surrounding expander 2116 and being held thereto by friction or other means, is fixed to an inner surface of drill pipe 2202. Since collapsible sleeve 2114 is fixed to drill pipe 2202 by fixing element F at lower ring 2118, collapsible flexible sleeve 2114 does not move relative to the pipe as expander 2116 is actuated in and out of drill pipe 2202. Instead, collapsible flexible sleeve 2114 compresses, collapses, or rolls up over itself to move to a collapsed position (shown in FIG. 22A). In this manner, collapsible flexible sleeve 2114 is moved to a position where it is mostly or wholly contained within the walls of drill pipe 2202.

As shown, in the collapsed position, collapsible flexible sleeve 2114 is disposed behind an opening end 2204 of drill pipe 2202. In the collapsed position, flexible sleeve 2114 and expander 2116 are protected by end 2204 of drill pipe 2202 from damage that may occur while moving or mating pipe ends together. In other words, the walls of the pipe shield the flexible sleeve 2114 and expander 2116 from colliding and being damaged with other elements during movement of the pipe.

In order for collapsible flexible sleeve 2114 to contact a dielectric internal protective coating in another pipe end, collapsible flexible sleeve 2114 must move from the collapsed position to an extended position so that collapsible flexible sleeve 2114 may extend into another pipe end and into contact with an internal protective coating. FIG. 22B shows the collapsible flexible sleeve 2114 in the extended state. As shown in FIG. 22B, collapsible flexible sleeve 2114 extends out of the end 2204 of drill pipe 2202, thus allowing collapsible flexible sleeve 2114 to contact an internal protective coating in another pipe of the pipe string.

When male connection end 2100 is connected to a female connection end, collapsible flexible sleeve 2114 may initially be in either a collapsed state or an extended state. In at least one configuration, collapsible flexible sleeve 2114 may be in a collapsed state when the drill pipes are all connected (similar to that shown in FIG. 19A). The flow of liquid and mud may act to move the collapsible flexible sleeve 2114 to move to the extended state. For example, as shown in FIG. 22A, collapsible flexible sleeve 2114 is in the collapsed state where collapsible flexible sleeve 2114 is compressed or rolled up over expander 2116. Flow of mud through drill pipe 2202 may exert force on expander 2116 causing it to be pushed into collapsible flexible sleeve 2114, at which point collapsible flexible sleeve 2114 extends and unrolls from over expander 2116 to allow collapsible flexible sleeve 2114 and expander 2116 to extend outward from end 2204 of drill pipe 2202 (shown in FIG. 22B). When extended out of drill pipe 2202, collapsible flexible sleeve 2114 may contact an internal protective coating inside the pipe string (similar to as shown in FIG. 20B). The fixing element F on lower ring 2118 of collapsible flexible sleeve 2114 restricts movement of the expander 2116 and collapsible flexible sleeve 2114 to hold them in place in drill pipe 2202.

Collapsible flexible sleeve 2114 may be an elastomer material with good dielectric, stretching, strength, and elastic properties. For example, collapsible flexible sleeve 2114 may be made of elastomers such as Hydrogenated nitrile (HNBR), hydrogenated acrylonitrile butadiene, and fluoroelastomers, such as vinylidene fluoride and propylene. This list is not exhaustive, those skilled in the art will appreciate that many different types of elastomers may be used for flexible sleeve 1614 in order to meet desired elasticity and wave propagation properties. Furthermore, lower ring 2118 of collapsible flexible sleeve 2114 may be made of a same material as the rest of collapsible flexible sleeve 2114 or may be made of a different material.

For example, lower ring 2118 may be made of a material that creates low friction and facilitates sliding between lower ring 2118 and expander 2116 so that collapsible flexible sleeve 2114 may easily move from the collapsed position to the extended position. Materials for lower ring 2118 may include one or more of plastic, nylon, PVC, metal, glass, ceramic, or any other material suitable for the purpose of lowering friction between expander 2116 and collapsible flexible sleeve 2114.

As described herein, many methods exist for fixing elements inside of drill pipes. Such elements may include elements described herein that are fixed, connected, or adhered inside a drill pipe. FIGS. 23A and 23B illustrate an inside pipe element 2314 that is fixed within a drill pipe 2300. Inside pipe element 2314 may be any element fixed inside a pipe such as flexible sleeve 1614, collapsible flexible sleeve 2114, or any other element fixed inside drill pipe 2300.

FIGS. 23A and 23B further illustrate a clamp 2302 for holding inside pipe element 2314 inside drill pipe 2300. The operation of clamp 2302 for holding element 2314 inside drill pipe 2300 may function as follows. As illustrated in FIG. 23A, inside pipe element 2314 may include a clamp flange 2315. Clamp 2302 may be a ring-shape that allows the cylindrical shaped inside pipe element 2314 to be inserted through clamp 2302. As shown, clamp flange 2315 may have a cone shape where the diameter of clamp flange 2315 expands outward. Other shapes may be used such as cylindrical or other shapes. Clamp 2302 may engage with flange 2315. Flange 2315 may have a diameter of a size the same or larger than clamp 2302. Accordingly, as clamp 2302 slides over flange 2315 of inside pipe element 2314, clamp 2302 expands outward to enlarge clamp 2302 within drill pipe 2300.

Clamp 2302 may include an expansion notch 2306 to facilitate expansion of clamp 2302 within drill pipe 2300. Expansion notch 2306 may be a break in one or more edges of clamp 2302 to allow for opening, flexing, and expansion of clamp 2302.

When in an unexpanded state, clamp 2302 may be of a diameter that allows clamp 2302 to be inserted within drill pipe 2300 without significant obstruction inhibiting the insertion of the clamp. Alternatively, clamp 2302 may be preinstalled in a groove within drill pipe 2300. Once element 2314 is inserted into clamp 2302 within drill pipe 2300, clamp 2302 expands due to flange 2315 forcing clamp 2302 outward. FIG. 23B shows that expansion of clamp 2302 within drill pipe 2300 causes clamp 2302 to engage with groove 2304 in drill pipe 2300. As shown within the pipe 2300, the outward expansion of clamp 2302 expands edges of clamp 2302 into groove 2304, and inside pipe element 2314 is thereby held in the drill pipe 2300 and may be firmly placed within drill pipe 2300 through the flow of mud through the pipe string.

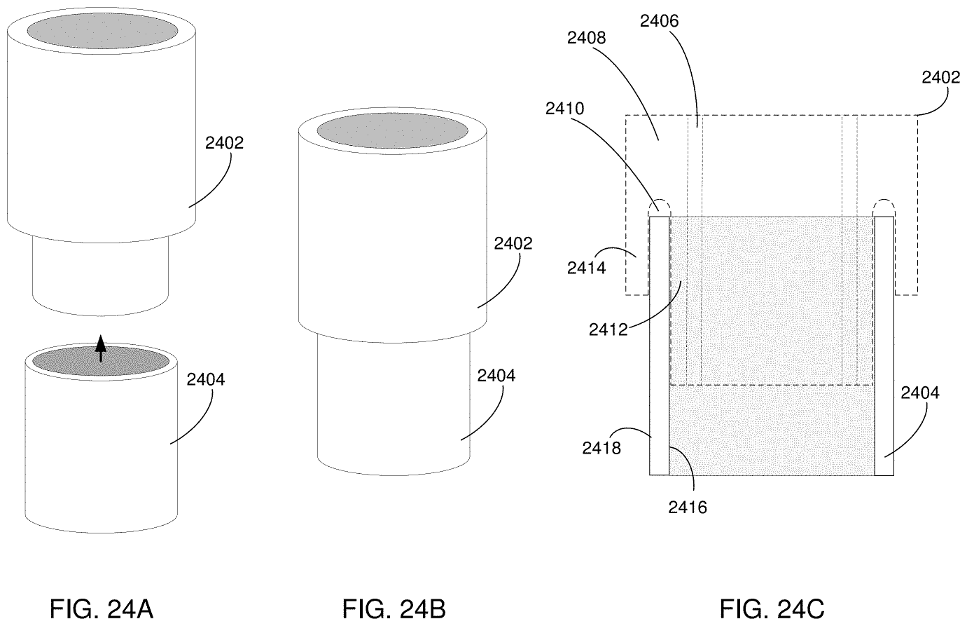

FIGS. 24A-24C illustrate another embodiment of a connecting element for connecting pipes together and for creating a dielectric path for propagation of waves, signals, and for communication along a pipe string. FIG. 24A illustrates a connection including a female connection end 2402 and a male connection end 2404 where the connection ends are separated from each other. The female and male connection ends 2402 and 2404 are shown in a separated configuration in FIG. 24A. Female connection end 2402 may include a pipe covered in a dielectric/elastomer material. Male connection end 2404 may include a flexible sleeve made of a dielectric/elastomer material and may additionally include a rigid pipe or expander within the flexible sleeve such as is shown in FIG. 21B. FIG. 24B shows male connection end 2404 and female connection end 2402 in a connected state. The connection between the connection ends is shown more explicitly in FIG. 24C.

FIG. 24C shows an internal cross-sectional view of female connection end 2402 (shown in dashed lines) connected to male connection end 2404. As shown in FIG. 24C, female connection end 2402 may include an inner pipe 2406 and an elastomer layer 2408 disposed on an outer surface of inner pipe 2406. Elastomer layer 2408 may further include a groove 2410 formed in the elastomer layer 2408 that receives the male connection end 2404. The groove 2410 may be formed in the elastomer layer 2408 such that an inner elastomer layer 2412 and an outer elastomer layer 2414 define the boundaries of groove 2410 as shown in FIG. 24C.

As shown in FIG. 24C, when male connection end 2404 is received within groove 2410 of female connection end 2402, the inner elastomer layer 2412 and outer elastomer layer 2414 may contact an inner surface 2416 and an outer surface 2418 of male connection end 2404. Male connection end may be entirely made of an elastomer material. Alternatively, male connection end 2404 may include a pipe where one or more of the inner surface 2416 and the outer surface 2418 may be covered in an elastomer material for propagating waves and signals along the pipe string. With male connection end 2402 disposed within groove 2410 of female connection end, the dielectric elastomer layer 2408 of female connection end 2402 is in contact with elastomer material of male connection end 2404, thus forming a dielectric path for propagating waves and signals along a pipe string.

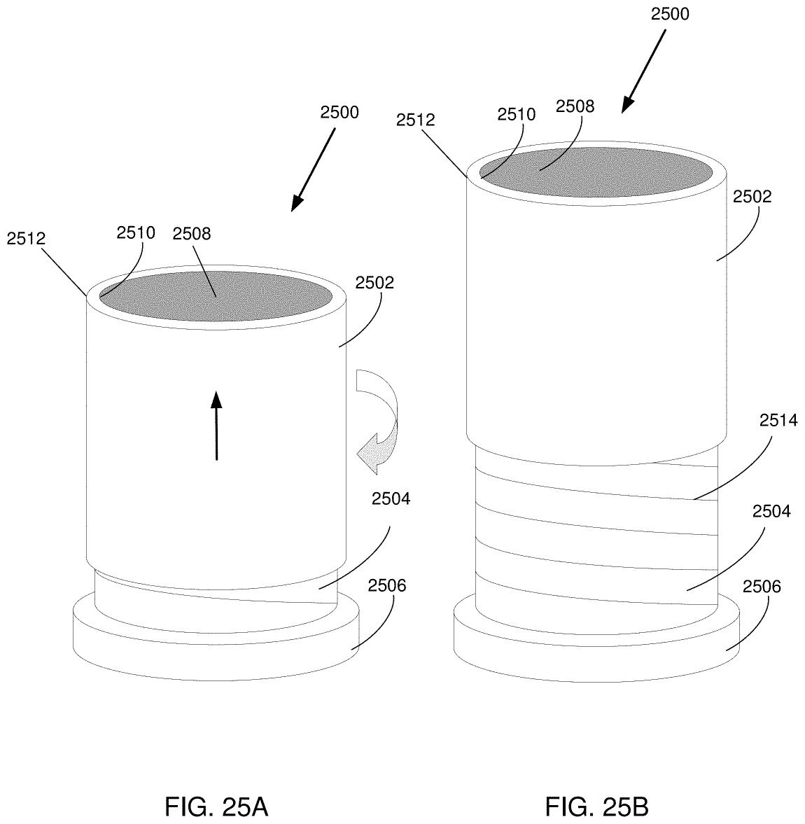

FIGS. 25A and 25B illustrate an alternative connection end according to at least one embodiment. FIG. 25A illustrates connection device 2500 which may include a connection portion 2502 and a threaded portion 2504. Connection portion 2502, similar to male connection end 2404 in FIGS. 24A-24C, may be entirely made of an elastomer material, or alternatively, male may include a pipe with an opening 2508 where one or more of an inner surface 2510 and an outer surface 2512 may be covered in an elastomer material for propagating waves and signals along the pipe string. Connection end 2500, similar to male connection end 2404 in FIGS. 24A-24C, may engage with an elastomer layer of a female connection end, such as female connection end 2402 and groove 2410.

Threaded portion 2504 engages with connection portion 2502 via threads 2514 formed on the outside of threaded portion 2504. Matching threads, or protrusions, or grooves, or other structures for engaging with threads are formed on an inside of connection portion 2502 to engage with threads 2514. The threads 2514 may be right hand threaded or left hand threaded. In FIGS. 25A and 25B, the threads are configured such that a clockwise turn of connection portion 2502 will cause connection portion 2502 to move upward to extend connection device 2500. FIG. 25A shows connection device 2500 in a retracted state and FIG. 25B shows connection device 2500 in an extended state. Once in the extended state, a counter-clockwise turn of the connection portion 2502 will move the connection device 2500 back to the retracted state shown in FIG. 25A.

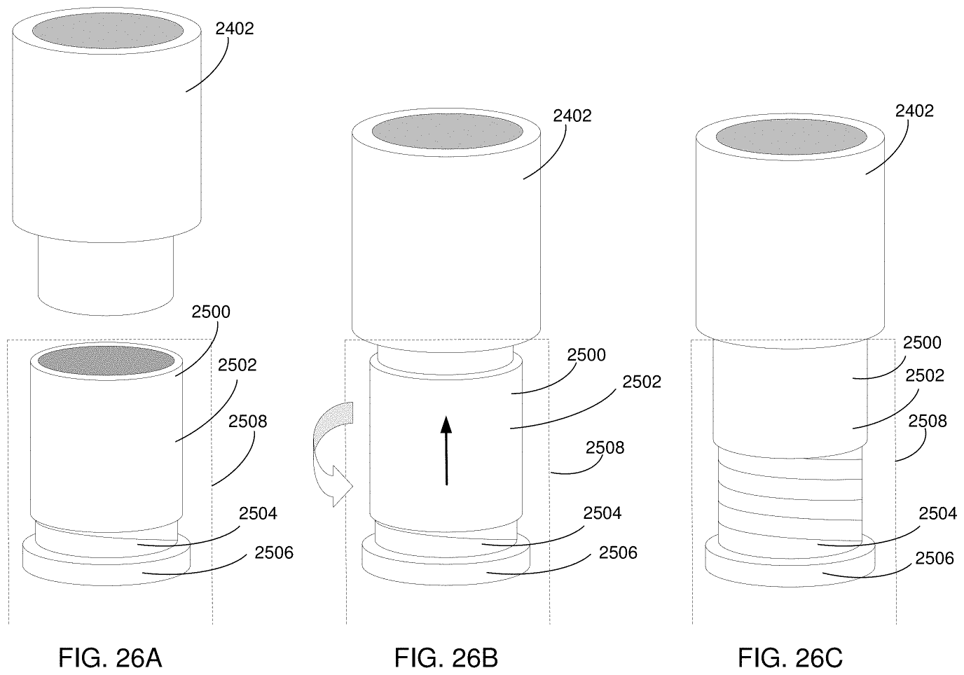

FIGS. 26A-26C illustrate a sequence of connection device 2500 engaging with connection end 2402. When connection device 2500 is disposed within a pipe 2508, connection device 2500 may be clamped/fixed in place within the pipe using flange 2506 and a clamp, such as clamp 2302 described in FIGS. 23A and 23B. By the clamp, connection device 2500 is firmly held in place within pipe 2508.

Steps of engaging connection device 2500 with connection end 2402 will now be described with reference to FIGS. 26A-26C. FIG. 26A shows connection device 2500 separated from connection end 2402. In FIG. 26B, connection end 2402 and connection device 2500 are moved into a position where connection end 2402 is in contact with connection portion 2502 of connection device 2500. With the threaded portion 2504 of connection device 2500 fixed to pipe 2508, threaded portion 2504 will turn at a same rate as pipe 2508 if the pipe 2508 is turned. However, because connection portion 2502 is not fixed itself to pipe 2508, connection portion 2502 is free to rotate about the threaded portion 2504 and extend or retract relative to the threaded portion 2504.

As shown in FIG. 26B, connection portion 2502 is in contact with connection end 2402. It will be appreciated that the connectors are shown as in a position where the ends of the connectors are contacting each other. Friction between connection end 2402 and connection portion 2502 may hold connection portion 2502 rotationally stationary relative to connection end 2402 as pipe 2508 rotates. Pipe 2508 may rotate in a counter-clockwise direction as shown. As connection end 2402 is held still and pipe 2508 rotates, threaded portion 2504 of connection device 2502 rotates relative to connection portion 2502. The rotation of connection portion 2502 and threaded portion 2504 relative to each other causes connection portion 2502 to extend upward into connection end 2402. After extending upward, connection portion 2502 is disposed within connection end 2402 in a same configuration as shown in FIG. 24C, where connection portion 2502 is seated within groove 2410 and between inner elastomer layer 2412 and outer elastomer layer 2414. By this configuration, connection between connection device 2500 and connection end 2402 may be achieved to form a dielectric, elastomer path along which waves and signals may propagate through a pipe string. Connection device 2500 is not limited to what is shown in FIGS. 25A-26C. Threads 2514 may be either right hand thread or left hand thread depending on circumstances and desires of a user. As illustrated in FIG. 26C, the connectors are shown in a position where the threaded extendable connector may be extended upward into the connector sleeve.

According to the above-described embodiments in FIGS. 16A-26C a drill pipe connection 1600 may be formed to ensure that a dielectric path/Skin Effect waveguide extends down hole in a pipe string and ensures that a waveguide path extends through end to end connections of drill pipes. Furthermore, the connections are fluid tight and reliable for applications involving drilling and down hole communications.

It will be appreciated that these embodiments may be modified in many ways without defeating the purposes of the disclosure. For example, FIGS. 16A-26C illustrate a case where a large diameter pipe (e.g., female connection end 1606) receives a smaller diameter pipe (e.g., male connection end 1602) therein and the flexible sleeve 1614. In an alternative embodiment, two similar/same sized drill pipes may be made to abut against each other. An end of a first pipe of the drill pipes may include a flexible sleeve and an end of a second pipe of the drill pipes may include an internal protective coating on an inner surface thereof. Then the pipes may be made to abut each other and be adhered, clamped or fastened together. The flexible sleeve may extend into an end of the second drill pipe and expand to contact the internal protective coating. In this way an embodiment may be accomplished wherein the pipes are the same size at the connection end. Additionally, an embodiment may be made wherein the flexible sleeve is seated in the female connection end and the internal protective coating is in the male connection end in contrast to the embodiment described above. The above disclosure may be practiced in numerous different configurations like those mentioned here.

Any of the embodiments described and shown in FIGS. 16A-26C may be modified to include a metal waveguide extending along the length of a pipe string in order to provide a path for conducting electrical signals along the drill pipe string. The metal waveguide may be between an elastomer and a pipe surface, may be embedded in the elastomer, or may be disposed on the elastomer. Additionally, metal connections may be included at any connection ends of the connection devices described herein in order to allow a metal waveguide of a first connection to contact a metal waveguide of a second connection to form a continuous waveguide path over connection sites in the pipe string. In addition, in some embodiments embedded electrical connections may be utilized within the flexible sleeve. Further, electrical connectors or contacts, inductive or capacity couples, or seals between string components may be implemented without departing from the scope of the disclosure.

Additionally, the clamps described and shown in FIGS. 23A-23B may be used to fix any of the described elements within a pipe, including elements such as flexible sleeve 1614, expander 2116, collapsible flexible sleeve 2114, inside pipe element 2314, male connection end 2404, connection device 2500, and/or any other suitable element that is fixed within a pipe.

The systems and embodiments disclosed herein may be used in any of the following ways (one or more of which at the same time): within a “single-conductor” communication system which represents a disruptive introduction of technology to the field of downhole telemetry; within an electromagnetic surface waveguide system, not a transmission line system; a system with no electrical couples or electrical contacts; in a system that uses existing geometrical requirements of concentricity and IPC for pipe in order to couple a signal from pipe to pipe; a system in a system where electromagnetic wave travels in the dielectric medium (e.g., between an IPC and metallic pipe wall; within the 100 MHz to 100 GHz (VHF to SHF) bands and/or higher for extremely fast communication and data throughput; in a system that works far beyond the current fastest telemetry system (hundreds of times) that is limited to a 5 Mhz carrier frequency using a coax cable and inductive couplers; within a system using bidirectional communications; within a system having the ability to carry multiple bands for multiple purposes and/or which can easily accommodate multiple equivalent Wi-Fi or 4G bands; as part of a system to transmit power to loads located at a distance from a power source (e.g., transmit along a single waveguide to a load); a system that does not require an electrical return path; in a system that does not interfere with mud flow in the pipes; and/or a system that will need less repeaters than existing systems, such as two or three instead of 20 for a four-mile well bore.

The systems and embodiments may be easily manufactured due to one or more of the following in some embodiments: easy conversion of pipe components and may use existing pipe manufacturing processes and requirements; no twisted pair, parallel line or coaxial cables inserted in the pipe (or on the outside of the pipe); dramatically lower conversion costs as compared to that of current wired pipe; systems may not require long lead times or special and expensive pipe modifications such as gun-drilling or boring or machining; systems may not use expensive inductive couplers; systems may not require a tensioned cable; systems may not require armored cables; systems may not require a conductive pipe embedded within a pipe, systems may not be limited by physics of acoustic propagation; systems may not require a transceiver at every joint of pipe; systems may not require electrical conductors in some embodiments.

Embodiments may also provide one or more of the following advantages during usage in the field: may not require especial handling of the pipe in the rig, because it can be treated as conventional pipe and there are no exposed electrical couplers to damage; embodiments may not change the recommended make-up torque (RMUT) of string components (torque specs); and/or existing pipe inventory can be easily converted.

### EXAMPLES

The following examples pertain to further embodiments.

Example 1 is a system for a single-line transmission along a plurality of pipes. The system includes a plurality of pipes connected end-to-end forming a pipe string. Each pipe of the plurality of pipes comprises an exterior wall, an internal protective coating, and a waveguide. The waveguide for each pipe of the plurality of pipes is connected to at least one other waveguide for at least one other pipe such that a wave path is formed that extends a length of the plurality of pipes. The system includes a transceiver configured to transmit a communication along the wave path.

Example 2 is a system as in Example 1, wherein the waveguide comprises an embedded waveguide attached to one or more of: an interior surface of the exterior wall of each of the plurality of pipes; or a surface of the internal protective coating of each of the plurality of pipes; wherein the embedded waveguide comprises a plated conductor.

Example 3 is a system as in any of Examples 1-2, wherein the waveguide comprises a spiral path such that mechanical relief is provided to the waveguide during bending or stretching of any of the plurality of pipes.

Example 4 is a system as in any of Examples 1-3, wherein the waveguide comprises surface waves propagating between a dielectric difference between the exterior wall and the internal protective coating of each of the plurality of pipes.

Example 5 is a system as in any of Examples 1-4, wherein each pipe of the plurality of pipes further comprises a waveguide coupler configured to carry the communication along the wave path between a first pipe secured to a second pipe.

Example 6 is a system as in any of Examples 1-5, wherein the waveguide coupler comprises a first waveguide coupler secured to a first end of a pipe and a second waveguide coupler secured to a second end of the pipe.

Example 7 is a system as in any of Examples 1-6, wherein the first waveguide coupler of a first pipe contacts the second waveguide coupler of a second pipe such that the wave path is not interrupted between the first pipe and the second pipe.

Example 8 is a system as in any of Examples 1-7, wherein the waveguide coupler comprises a spring metal sheet configured to conform to an interior cavity of the pipe without fully obstructing a flow of fluid through the pipe.

Example 9 is a system as in any of Examples 1-8, wherein the spring metal sheet further comprises one or more clamping ears configured to clamp the spring metal sheet to a surface of the interior cavity of the pipe and provide strain relief to the spring metal sheet against vertical and lateral forces.

Example 10 is a system as in any of Examples 1-9, wherein the spring metal sheet comprises a three-dimensional conical shape and is constructed of a flexible conductive material.

Example 11 is a system as in any of Examples 1-10, further comprising a transceiver housing configured to secure the transceiver to a pipe of the plurality of pipes.

Example 12 is a system as in any of Examples 1-11, further comprising a plurality of transceivers each configured to transmit and receive the communication along the wave path, wherein the plurality of transceivers are located intermittently along the plurality of pipes such that not every pipe of the plurality of pipes comprises a transceiver.

Example 13 is a method for transmitting a communication along a plurality of pipes. The method includes transmitting a communication from a transceiver. The transceiver is configured to transmit the communication along a wave path extending a length of a plurality of pipes connected end-to-end. Each pipe of the plurality of pipes comprises an exterior wall, an internal protective coating, and a waveguide. The waveguide for each pipe of the plurality of pipes is connected to at least one other waveguide for at least one other pipe such that the wave path extends the length of the plurality of pipes.

Example 14 is a method as in Example 13, wherein the waveguide comprises an embedded waveguide attached to one or more of: an interior surface of the exterior wall of each of the plurality of pipes; or a surface of the internal protective coating of each of the plurality of pipes; wherein the embedded waveguide comprises a plated conductor.

Example 15 is a method as in any of Examples 13-14, wherein the waveguide comprises a spiral path such that mechanical relief is provided to the waveguide during bending or stretching of any of the plurality of pipes.

Example 16 is a method as in any of Examples 13-15, wherein the waveguide comprises surface waves propagating between a dielectric difference between the exterior wall and the internal protective coating of each of the plurality of pipes.

Example 17 is a method as in any of Examples 13-16, wherein each pipe of the plurality of pipes further comprises a waveguide coupler configured to carry the communication along the wave path between a first pipe secured to a second pipe.

Example 18 is a method as in any of Examples 13-17, wherein the waveguide coupler comprises a first waveguide coupler secured to a first end of a pipe and a second waveguide coupler secured to a second end of the pipe.

Example 19 is a method as in any of Examples 13-18, wherein the first waveguide coupler of a first pipe contacts the second waveguide coupler of a second pipe such that the wave path is not interrupted between the first pipe and the second pipe.

Example 20 is a method as in any of Examples 13-19, wherein the waveguide coupler comprises a spring metal sheet configured to conform to an interior cavity of the pipe without fully obstructing a flow of fluid through the pipe.

Example 21 is a method as in any of Examples 13-20, wherein the spring metal sheet further comprises one or more clamping ears configured to clamp the spring metal sheet to a surface of the interior cavity of the pipe to provide strain relief to the spring metal sheet against vertical and lateral forces.

Example 22 is a method as in any of Examples 13-21, wherein the spring metal sheet comprises a three-dimensional conical shape and is constructed of a flexible conductive material.

Example 23 is a method as in any of Examples 13-22, wherein transmitting the communication from the transceiver comprises transmitting the communication through a plurality of transceivers each configured to transmit and receive the communication along the wave path, wherein the plurality of transceivers are located intermittently along the plurality of pipes such that not every pipe of the plurality of pipes comprises a transceiver.

Example 24 is a method as in any of Examples 13-23, wherein transmitting the communication from the transceiver comprises transmitting an instruction from a controller configured to manage automated downhole drilling of an oil rig, wherein the communication causes one or more components of the oil rig to execute the instruction.

Example 25 is an apparatus including means to perform a method of any of Examples 1-24.

Example 26 is a machine-readable storage including machine-readable instructions, when executed, to implement a method or realize an apparatus of any of Examples 1-24.

Example 27 is a system including a plurality of pipes connected end-to-end to form a pipe string. The system includes a first pipe including an exterior wall, an interior surface, and a first connection end comprising a hollow flexible sleeve that is disposed on the interior surface of the first pipe and is made of an elastomer material. The system further comprises a second pipe including an exterior wall, an interior surface, an internal protective coating, and a second connection end configured to receive the hollow flexible sleeve of the first pipe therein. When the first connection end is connected to the second connection end, the hollow flexible sleeve contacts the internal protective coating of the second pipe.

Example 28 is the system of Example 27, wherein the hollow flexible sleeve and the internal protective coating form a waveguide such that a wave path is formed that extends a length of the pipe string.

Example 29 is the system of any of Examples 27-28, wherein pressure of fluids flowing through the first pipe causes a diameter of the hollow flexible sleeve to expand into the second connection end and to expand into contact with internal protective coating of the second pipe.

Example 30 is the system of any of Examples 27-29, wherein hollow flexible sleeve is collapsible such that a top portion of the hollow flexible sleeve is collapsible into a bottom portion of the hollow flexible sleeve. The hollow flexible sleeve includes a collapsed position, in which the top portion is disposed within the bottom portion of the hollow flexible sleeve. The hollow flexible sleeve includes in an extended position, in which the top portion extends outward from the bottom portion.

Example 31 is the system of any of Examples 27-30, wherein the hollow flexible sleeve is initially in the collapsed position within the first connection end. The pressure of fluids flowing through the first pipe cause the hollow flexible sleeve to move from the collapsed position to the extended position. The pressure of fluids flowing through the first pipe causes a diameter of the hollow flexible sleeve to expand into the second connection end and to expand into contact with internal protective coating of the second pipe.

Example 32 is the system of any of Examples 27-31, wherein the hollow flexible sleeve comprises one or more protrusions extending outward from an outer surface of the hollow flexible sleeve. The interior surface of the first pipe comprises one or more grooves formed therein corresponding to the one or more protrusions. The hollow flexible sleeve is seated in the first connection end via the one or more protrusions being disposed in the one or more grooves.

Example 33 is the system of any of Examples 27-32, further comprising a transceiver configured to transmit a signal along the wave path.

Example 34 is the system of any of Examples 27-33, wherein the first connection end comprises a first exterior section and a second exterior section disposed adjacent to the first exterior section. A diameter of the first exterior section is larger than a diameter of the second exterior section.

Example 35 is the system of any of Examples 27-34, wherein the second connection end comprises a first hollow cavity formed therein, and a second hollow cavity formed therein adjacent to the first hollow cavity. A diameter of the first hollow cavity is larger than a diameter of the second hollow cavity. The diameter of the first hollow cavity is substantially the same as the diameter of the second exterior section of the first connection end such that the second exterior section is received into the first hollow cavity when the first pipe and the second pipe are connected.

Example 36 is the system of any of Examples 27-35, wherein the internal protective coating is disposed on an interior surface of the second hollow cavity. When the second exterior section of the first connection end is disposed in the first hollow cavity of the second connection end, the hollow flexible sleeve of the first connection end extends outward into the second hollow cavity of the second connection end and is disposed adjacent to the internal protective coating.

Example 37 is the system of any of Examples 27-36, wherein, when the second exterior section of the first connection end is disposed in the first hollow cavity of the second connection end, a lower surface of the first section rests on an upper surface of the second connection end and a lower surface of the second section rests on a support surface formed within the second connection end at a point where the first hollow cavity and the second hollow cavity meet.

Example 38 is the system of any of Examples 27-37, wherein each of the of the plurality of pipes in the pipe string comprises an exterior wall, an interior surface, an internal protective coating, a first connection end including a hollow flexible sleeve on one end, and a second connection end on another end.

Example 39 is the system of any of Examples 27-38, wherein the first connection end and the second connection end together form a pipe connection and the system further comprises a plurality of pipe connections.

Example 40 is the system of any of Examples 27-39, wherein the waveguide comprises an embedded waveguide attached to one or more of an interior surface of the exterior wall of each of the plurality of pipes or a surface of the internal protective coating of each of the plurality of pipes. The embedded waveguide comprises a plated conductor.

Example 41 is the system of any of Examples 27-40, wherein the waveguide comprises an embedded cable that has a dielectric sheeting, wherein the embedded cable is attached to one or more of an interior surface of the exterior wall of each of the plurality of pipes or a surface of the internal protective coating of each of the plurality of pipes.

Example 42 is a pipe connection device. The pipe connection device includes a first connection end including an exterior wall, an interior surface, and a hollow flexible sleeve that is disposed on the interior surface of the first pipe and is made of an elastomer material. A second connection end configured to receive the hollow flexible sleeve of the first pipe therein includes an exterior wall, an interior surface, and an internal protective coating. When the first connection end is connected to the second connection end the hollow flexible sleeve contacts the internal protective coating of the second connection end.

Example 43 is the pipe connection device of Example 42 wherein the hollow flexible sleeve and the internal protective coating form a waveguide such that a wave path is formed.

Example 44 is the pipe connection device of any of Examples 42-43, wherein pressure of fluids flowing through the pipe connection causes a diameter of the hollow flexible sleeve to expand into the second connection end and to expand into contact with internal protective coating of the second connection end.

Example 45 is the pipe connection device of any of Examples 42-44, wherein the hollow flexible sleeve is collapsible such that a top portion of the hollow flexible sleeve is collapsible into a bottom portion of the hollow flexible sleeve. The hollow flexible sleeve includes a collapsed position, in which the top portion is disposed within the bottom portion of the hollow flexible sleeve. The hollow flexible sleeve includes in an extended position, in which the top portion extends outward from the bottom portion.

Example 46 is the pipe connection device of any of Examples 42-45, wherein the hollow flexible sleeve is initially in the collapsed position within the first connection end. The pressure of fluids flowing through the first connection end cause the hollow flexible sleeve to move from the collapsed position to the extended position. The pressure of fluids flowing through the first connection end causes a diameter of the hollow flexible sleeve to expand into the second connection end and to expand into contact with internal protective coating of the second connection end.

Example 47 is the pipe connection device of any of Examples 42-46, wherein the hollow flexible sleeve comprises one or more protrusions extending outward from an outer surface of the hollow flexible sleeve. The interior surface of the first connection end comprises one or more grooves formed therein corresponding to the one or more protrusions. The hollow flexible sleeve is seated in the first connection end via the one or more protrusions being disposed in the one or more grooves.

Example 48 is the pipe connection device of any of Examples 42-47 further comprising an expanding member disposed within the hollow flexible sleeve to expand the hollow flexible sleeve to contact the internal protective coating.

Example 49 is the pipe connection device of any of Examples 42-48, wherein the hollow flexible sleeve is fixed to the interior surface of the first connection end. The expanding member is configured to alternate between an extended position wherein the expanding member and the hollow flexible sleeve extend out of first connection end and a retracted position where the expanding member and the hollow flexible sleeve are retracted inside of the first connection end.

Example 50 is the pipe connection device of any of Examples 42-49, wherein, in the extended position, the hollow flexible sleeve is fully extended over the expanding member. In the retracted position, the hollow flexible sleeve is compressed, rolled up, or collapsed over the expanding member.

Example 51 is the pipe connection device of any of Examples 42-50, wherein, the hollow flexible sleeve comprises a ring at the base of the hollow flexible sleeve that is made of a different material than the rest of the hollow flexible sleeve. The ring is configured to slide on the expanding member to facilitate compression or rolling up of the hollow flexible sleeve over the expanding member.

Example 52 is the pipe connection device of any of Examples 42-51, wherein, the hollow flexible sleeve is fixed to the interior service by a ring-shaped expansion clamp that engages with a flange of the hollow flexible sleeve. The expansion clamp expands in an outward direction when the expansion clamp engages with the flange. As the expansion clamp expands, the expansion clamp engages with a groove formed in the interior surface.

Example 53 is a pipe connection device comprising a first connection end comprising an exterior wall an interior surface, and a hollow connection sleeve that is disposed on the interior surface of the first pipe and comprises an elastomer material. The pipe connection device further comprises a second connection end configured to receive the hollow flexible sleeve of the first pipe therein comprising an exterior wall, an interior surface, and an elastomer layer. When the first connection end is connected to the second connection end the hollow connection sleeve contacts the elastomer layer of the second connection end. The elastomer layer comprises a groove formed therein for receiving an end of the hollow connection sleeve.

Example 54 is the pipe connection device of Example 53, comprising a connection portion that engages with the groove of the elastomer layer and a threaded portion disposed within the connection portion. Wherein rotation of the threaded portion causes the connection portion to rotate upward such that hollow connection sleeve extends upward out of the connection end and into the groove of the elastomer layer, thereby connecting first connection end and the second connection end together.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

What is claimed is:

1. A system comprising a plurality of pipes connected end-to-end to form a pipe string, the system comprising:
a first pipe comprising:
an exterior wall;
an interior surface;
an internal protective coating; and
a first connection end comprising a hollow flexible sleeve that is disposed on the interior surface of the first pipe and is made of an elastomer material;
a second pipe comprising:
an exterior wall;
an interior surface;
an internal protective coating; and
a second connection end configured to receive the hollow flexible sleeve of the first pipe therein;
wherein, when the first connection end is connected to the second connection end, the hollow flexible sleeve contacts the internal protective coating of the second pipe.

2. The system of claim 1, wherein the hollow flexible sleeve and the internal protective coating form a waveguide such that a wave path is formed that extends a length of the pipe string.

3. The system of claim 1, wherein pressure of fluids flowing through the first pipe causes a diameter of the hollow flexible sleeve to expand into the second connection end and to expand into contact with internal protective coating of the second pipe.

4. The system of claim 1, wherein hollow flexible sleeve is collapsible such that a top portion of the hollow flexible sleeve is collapsible into a bottom portion of the hollow flexible sleeve;
wherein the hollow flexible sleeve includes a collapsed position, in which the top portion is disposed within the bottom portion of the hollow flexible sleeve; and
wherein the hollow flexible sleeve includes in an extended position, in which the top portion extends outward from the bottom portion.

5. The system of claim 4, wherein the hollow flexible sleeve is initially in the collapsed position within the first connection end;
wherein the pressure of fluids flowing through the first pipe cause the hollow flexible sleeve to move from the collapsed position to the extended position; and
wherein the pressure of fluids flowing through the first pipe causes a diameter of the hollow flexible sleeve to expand into the second connection end and to expand into contact with internal protective coating of the second pipe.

6. The system of claim 1,
wherein the hollow flexible sleeve comprises one or more protrusions extending outward from an outer surface of the hollow flexible sleeve;
wherein the interior surface of the first pipe comprises one or more grooves formed therein corresponding to the one or more protrusions
wherein the hollow flexible sleeve is seated in the first connection end via the one or more protrusions being disposed in the one or more grooves.

7. The system of claim 1, further comprising a transceiver configured to transmit a signal along the wave path.

8. The system of claim 1, wherein the first connection end comprises a first exterior section and a second exterior section disposed adjacent to the first exterior section;
wherein a diameter of the first exterior section is larger than a diameter of the second exterior section.

9. The system of claim 8, wherein the second connection end comprises a first hollow cavity formed therein, and a second hollow cavity formed therein adjacent to the first hollow cavity;
wherein a diameter of the first hollow cavity is larger than a diameter of the second hollow cavity;
wherein the diameter of the first hollow cavity is substantially the same as the diameter of the second exterior section of the first connection end such that the second exterior section is received into the first hollow cavity when the first pipe and the second pipe are connected.

10. The system of claim 9, wherein the internal protective coating is disposed on an interior surface of the second hollow cavity; and
wherein, when the second exterior section of the first connection end is disposed in the first hollow cavity of the second connection end, the hollow flexible sleeve of the first connection end extends outward into the second hollow cavity of the second connection end and is disposed adjacent to the internal protective coating.

11. The system of claim 10, wherein, when the second exterior section of the first connection end is disposed in the first hollow cavity of the second connection end, a lower surface of the first section rests on an upper surface of the second connection end and a lower surface of the second section rests on a support surface formed within the second connection end at a point where the first hollow cavity and the second hollow cavity meet.

12. The system of claim 1, wherein each of the of the plurality of pipes in the pipe string comprises an exterior wall, an interior surface, an internal protective coating, a first connection end including a hollow flexible sleeve on one end, and a second connection end on another end.

13. The system of claim 1, wherein the first connection end and the second connection end together form a pipe connection,
wherein the system further comprises a plurality of pipe connections.

14. The system of claim 2, wherein the waveguide comprises an embedded waveguide attached to one or more of:
an interior surface of the exterior wall of each of the plurality of pipes; or
a surface of the internal protective coating of each of the plurality of pipes;
wherein the embedded waveguide comprises a plated conductor.

15. A pipe connection device comprising:
a first connection end comprising:
an exterior wall;
an interior surface; and
a hollow flexible sleeve that is disposed on the interior surface of the first pipe and is made of an elastomer material;
a second connection end configured to receive the hollow flexible sleeve of the first pipe therein comprising:
an exterior wall;
an interior surface; and
an internal protective coating;
wherein when the first connection end is connected to the second connection end the hollow flexible sleeve contacts the internal protective coating of the second connection end.

16. The pipe connection device of claim 15, wherein the hollow flexible sleeve and the internal protective coating form a waveguide such that a wave path is formed.

17. The pipe connection device of claim 15, wherein pressure of fluids flowing through the pipe connection causes a diameter of the hollow flexible sleeve to expand into the second connection end and to expand into contact with internal protective coating of the second connection end.

18. The pipe connection device of claim 15, wherein the hollow flexible sleeve is collapsible such that a top portion of the hollow flexible sleeve is collapsible into a bottom portion of the hollow flexible sleeve;
wherein the hollow flexible sleeve includes a collapsed position, in which the top portion is disposed within the bottom portion of the hollow flexible sleeve; and
wherein the hollow flexible sleeve includes in an extended position, in which the top portion extends outward from the bottom portion.

19. The pipe connection device of claim 18, wherein the hollow flexible sleeve is initially in the collapsed position within the first connection end;
wherein the pressure of fluids flowing through the first connection end cause the hollow flexible sleeve to move from the collapsed position to the extended position; and
wherein the pressure of fluids flowing through the first connection end causes a diameter of the hollow flexible sleeve to expand into the second connection end and to expand into contact with internal protective coating of the second connection end.

20. The pipe connection device of claim 15,
wherein the hollow flexible sleeve comprises one or more protrusions extending outward from an outer surface of the hollow flexible sleeve;
wherein the interior surface of the first connection end comprises one or more grooves formed therein corresponding to the one or more protrusions;
wherein the hollow flexible sleeve is seated in the first connection end via the one or more protrusions being disposed in the one or more grooves.

21. The pipe connection device of claim 15, further comprising:
an expanding member disposed within the hollow flexible sleeve to expand the hollow flexible sleeve to contact the internal protective coating.

22. The pipe connection device of claim 21, wherein the hollow flexible sleeve is fixed to the interior surface of the first connection end,
wherein the expanding member is configured to alternate between an extended position wherein the expanding member and the hollow flexible sleeve extend out of first connection end and a retracted position where the expanding member and the hollow flexible sleeve are retracted inside of the first connection end.

23. The pipe connection device of claim 15, wherein the hollow flexible sleeve is fixed to the interior surface of the first connection end using a clamp.

24. A pipe connection device comprising:
a first connection end comprising:
an exterior wall;
an interior surface; and
a hollow connection sleeve that is disposed on the interior surface of the first pipe and comprises an elastomer material;
a second connection end configured to receive the hollow flexible sleeve of the first pipe therein comprising:
an exterior wall;
an interior surface; and
an elastomer layer;
wherein when the first connection end is connected to the second connection end the hollow connection sleeve contacts the elastomer layer of the second connection end
wherein the elastomer layer comprises a groove formed therein for receiving an end of the hollow connection sleeve.

25. The pipe connection device of claim 24, wherein the hollow connection sleeve comprises:
a connection portion that engages with the groove of the elastomer layer; and
a threaded portion having threads and disposed within the connection portion;
wherein rotation of the threaded portion causes the connection portion to rotate upward such that hollow connection sleeve extends upward out of the connection end and into the groove of the elastomer layer, thereby connecting first connection end and the second connection end together.
